(19) United States
(12) Patent Application Publication
(10) Pub. No.: US 2021/0297991 A1
(43) Pub. Date: Sep. 23, 2021

(54) TRANSMISSION DEVICE, TRANSMISSION METHOD, RECEPTION DEVICE, AND RECEPTION METHOD

(71) Applicant: Sony Corporation, Tokyo (JP)

(72) Inventor: Kazuyuki TAKAHASHI, Tokyo (JP)

(73) Assignee: Sony Corporation, Tokyo (JP)

(21) Appl. No.: 17/261,703

(22) PCT Filed: Nov. 29, 2019
(86) PCT No.: PCT/JP2019/046727

§ 371 Date: Jan. 20, 2021

(30) Foreign Application Priority Data
Dec. 12, 2018 (JP) 2018-232141
Sep. 27, 2019 (JP) 2019-176540

(51) Int. Cl. H04W 72/00; H04W 72/04; H04L 1/00; H04B 7/10

(52) U.S. Cl. CPC H04W 72/005; H04W 72/0453; H04B 7/10; H04W 72/042; H04L 1/0071; H04W 72/0446

(57) ABSTRACT

The present technology relates to a transmission device, a transmission method, a reception device, and a reception method that enable introduction of a new broadcasting method more appropriately.

There is provided a transmission device including a generation unit that generates a transmission control signal including segment control information regarding a segment that is a division unit in a frequency domain as control information according to introduction of a second method compatible with a first method, and a transmission unit that transmits a transmission frame including the transmission control signal that is generated. The present technology can be applied to a transmission system compatible with a broadcasting method such as the ISDB-T method, for example.

### TECHNICAL FIELD

The present technology relates to a transmission device, a transmission method, a reception device, and a reception method, and particularly relates to a transmission device, a transmission method, a reception device, and a reception method that enable introduction of a new broadcasting method more appropriately.

### BACKGROUND ART

For example, in Japan, studies are being conducted on sophistication of terrestrial digital television broadcasting toward the next generation, and various technical methods are being studied (see, for example, Patent Document 1).

### CITATION LIST

### Patent Document

Patent Document 1: Japanese Patent Application Laid-Open No. 2018-101862

### SUMMARY OF THE INVENTION

### Problems to be Solved by the Invention

Now, when switching from an existing broadcasting method to a new broadcasting method compatible with the existing broadcasting method, it is demanded that the new broadcasting method is appropriately introduced.

The present technology has been made in view of such a situation, and makes it possible to more appropriately introduce a new broadcasting method.

### Solutions to Problems

A transmission device of one aspect of the present technology is a transmission device including a generation unit that generates a transmission control signal including segment control information regarding a segment that is a division unit in a frequency domain as control information according to introduction of a second method compatible with a first method, and a transmission unit that transmits a transmission frame including the transmission control signal that is generated.

A transmission method of one aspect of the present technology is a transmission method including, by a transmission device, generating a transmission control signal including segment control information regarding a segment that is a division unit in a frequency domain as control information according to introduction of a second method compatible with a first method, and transmitting a transmission frame including the transmission control signal that is generated.

In the transmission device and the transmission method of one aspect of the present technology, a transmission control signal including segment control information regarding a segment that is a division unit in a frequency domain is generated as control information according to introduction of a second method compatible with a first method, and a transmission frame including the transmission control signal that is generated is transmitted.

A reception device of one aspect of the present technology includes a reception unit that receives a transmission frame transmitted from a transmission device, and a demodulation unit that performs a demodulation process on a data signal obtained from the transmission frame on the basis of a transmission control signal obtained from the transmission frame that is received, in which the transmission control signal includes segment control information regarding a segment that is a division unit in a frequency domain as control information according to introduction of a second method compatible with a first method, and the demodulation unit performs a demodulation process regarding the segment on the basis of the segment control information.

A reception method of one aspect of the present technology includes, by a reception device including a reception unit that receives a transmission frame transmitted from a transmission device, and a demodulation unit that performs a demodulation process on a data signal obtained from the transmission frame on the basis of a transmission control signal obtained from the transmission frame that is received, performing on the basis of segment control information included in the transmission control signal and regarding a segment that is a division unit in a frequency domain as control information according to introduction of a second method compatible with a first method, a demodulation process regarding the segment.

In the reception device and the reception method of one aspect of the present technology, on the basis of segment control information included in the transmission control signal and regarding a segment that is a division unit in a frequency domain as control information according to introduction of a second method compatible with a first method, a demodulation process regarding the segment is performed.

The transmission device and the reception device of one aspect of the present technology may be independent devices or may be internal blocks constituting one device.

### BRIEF DESCRIPTION OF DRAWINGS

FIG. 1 is a diagram illustrating an example of a configuration of one embodiment of a transmission system to which the present technology is applied.

FIG. 2 is a diagram illustrating an example of bit allocation of a TMCC carrier.

FIG. 3 is a diagram illustrating details of bit allocation of TMCC information.

FIG. 4 is a diagram illustrating an example of a configuration of transmission parameter information.

FIG. 5 is a diagram illustrating an example of a carrier modulation mapping method.

FIG. 6 is a diagram illustrating an example of a convolutional coding rate.

FIG. 7 is a diagram illustrating an example of a length of time interleaving.

FIG. 8 is a diagram illustrating an example of the number of segments.

FIG. 9 is a diagram illustrating an example of new method introduction control information.

FIG. 10 is a diagram illustrating an example of segment control information.

FIG. 11 is a diagram illustrating an example of whether or not a new method is introduced for each layer.

FIG. 12 is a diagram illustrating an example of the number of segments in a B layer or a C layer.

FIG. 13 is a diagram illustrating an example of a configuration of transmission parameter information.

FIG. 14 is a diagram illustrating an example of a modulation method.

FIG. 15 is a diagram illustrating an example of a coding rate.

FIG. 16 is a diagram illustrating an example of a length of time interleaving.

FIG. 17 is a diagram illustrating an example of a segment configuration in a case where the new method is introduced with respect to an existing method.

FIG. 18 is a diagram illustrating an example of values of the segment control information.

FIG. 19 is a block diagram illustrating an example of a configuration of a transmission device.

FIG. 20 is a flowchart describing a flow of a transmission process.

FIG. 21 is a block diagram illustrating an example of a configuration of a reception device.

FIG. 22 is a flowchart describing a flow of a reception process.

FIG. 23 is a flowchart describing a flow of a reception process.

FIG. 24 is a diagram schematically illustrating transmission of an MIMO method.

FIG. 25 is a diagram describing an introduction method for introducing the new method while maintaining broadcasting of an ISDB-T method as the existing method.

FIG. 26 is a diagram describing an example of the segment control information in a case where the MIMO method can be used for introducing the new method.

FIG. 27 is a diagram describing frequency interleaving on a V polarized wave side of broadcasting of the new method in which the MIMO method is used.

FIG. 28 is a diagram describing a bit B110 to which information indicating that broadcasting performed in the B layer is broadcasting of the ISDB-T method as the existing method or the new method out of the segment control information is assigned.

FIG. 29 is a diagram describing a bit B111 to which information indicating that broadcasting of the new method performed in the B layer is broadcasting using the SISO method or the MIMO method out of the segment control information is assigned.

FIG. 30 is a diagram describing bits B112 to B114 to which information representing a carrier modulation method is assigned out of the segment control information.

FIG. 31 is a diagram describing bits B115 to B118 to which information representing the coding rate is assigned out of the segment control information.

FIG. 32 is a diagram describing bits B119 to B120 to which information representing the length of the time interleaving is assigned out of the segment control information.

FIG. 33 is a diagram describing a bit B121 to which, out of the segment control information, information indicating that the frequency interleaving on the V polarized wave side of the broadcasting of the new method using the MIMO method performed in the B layer is the intralayer interleaving or the interlayer interleaving is assigned.

FIG. 34 is a diagram illustrating an example of system identification in a second phase.

FIG. 35 is a diagram illustrating an example of a configuration of a computer.

### MODE FOR CARRYING OUT THE INVENTION

Hereinafter, embodiments of the present technology will be described with reference to the drawings. Note that the description will be made in the following order.
1. Embodiments of present technology
2. Modification example
3. Configuration of computer

### 1. Embodiments of Present Technology

(Configuration Example of Transmission System)

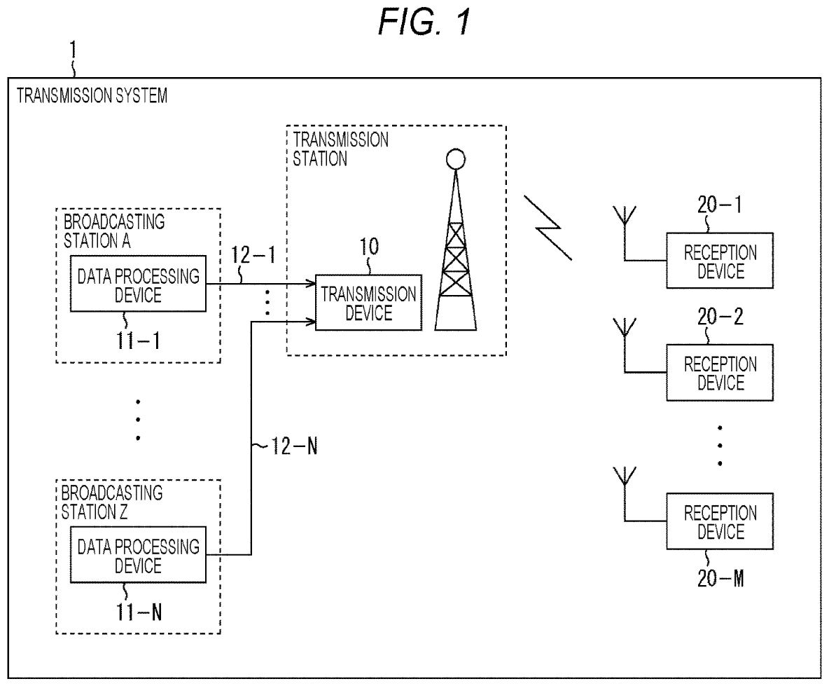

FIG. 1 is a diagram illustrating a configuration of one embodiment of a transmission system to which the present technology is applied. Note that the system is a logical collection of a plurality of devices.

In FIG. 1, a transmission system 1 is a system corresponding to a broadcasting method such as terrestrial digital television broadcasting. The transmission system 1 includes data processing devices 11-1 to 11-N (N is an integer of 1 or more) installed in facilities related to respective broadcasting stations, a transmission device 10 installed in a transmitting station, and reception devices 20-1 to 20-M (M is an integer of 1 or more) owned by respective users.

Furthermore, in the transmission system 1, the data processing devices 11-1 to 11-N and the transmission device 10 are connected via communication lines 12-1 to 12-N. Note that the communication lines 12-1 to 12-N can be dedicated lines, for example.

The data processing device 11-1 performs necessary processing such as encoding on data of broadcast content (for example, a broadcast program or the like) produced by the broadcasting station A, and transmits transmission data obtained as a result to the transmission device 10 via the communication line 12-1.

In the data processing devices 11-2 to 11-N, similarly to the data processing device 11-1, data of the broadcast content produced by each broadcasting station such as the broadcasting station B and the broadcasting station Z is processed, and transmission data obtained as a result is transmitted to the transmission device 10 via the communication lines 12-2 to 12-N.

The transmission device 10 receives the transmission data transmitted from the data processing devices 11-1 to 11-N on the broadcasting station side via the communication lines 12-1 to 12-N. The transmission device 10 performs necessary processing such as coding and modulation on the transmission data from the data processing devices 11-1 to 11-N, and transmits a broadcast signal obtained as a result from a transmission antenna installed at the transmitting station.

Thus, the broadcast signal from the transmission device 10 on the transmitting station side is transmitted to each of the reception devices 20-1 to 20-M by radio waves in a predetermined frequency band.

The reception devices 20-1 to 20-M are configured as a fixed receiver, such as a television receiver or a set top box (STB) for example, and are installed in a home of each user, or the like.

The reception device 20-1 receives the broadcast signal transmitted from the transmission device 10 by radio waves in a predetermined frequency band and performs necessary processing such as demodulation, decryption, and decoding, to thereby reproduce the broadcast content (for example, a broadcast program or the like) according to a channel selection operation by the user.

In the reception devices 20-2 to 20-M, similarly to the reception device 20-1, the broadcast signal from the transmission device 10 is processed, and the broadcast content corresponding to the channel selection operation by the user is reproduced.

In this manner, in the reception device 20, video of the broadcast content is displayed on the display, and sound synchronized with the video is output from the speaker, so that the user can watch the broadcast content such as a broadcast program.

Note that in the transmission system 1, the M reception devices 20 are a mixture of those compatible with an existing broadcasting method (existing method) and those compatible with a new broadcasting method (new method). Therefore, in the following description, the reception device 20 corresponding to the existing method is referred to as the existing method reception device 20L, and the reception device 20 corresponding to the new method is referred to as the new method reception device 20N.

Moreover, because the reception device 20 corresponding to both the existing method and the new method is assumed, the reception device 20 is referred to as a dual reception device 20D in the following description. However, in a case where it is not particularly necessary to distinguish the existing method reception device 20L, the new method reception device 20N, and the dual reception device 20D, it is simply referred to as the reception device 20.

Incidentally, in Japan, studies are being conducted toward the next generation of terrestrial digital television broadcasting. Here, as one of transition (migration) methods from the existing method (ISDB-T method) to the new method (next-generation method of the ISDB-T method), introduction of a compatible new method using the frequency band of the existing method is considered.

Here, the point that the new method is compatible with the existing method means that broadcasting of the new method can be performed using a part of the existing method.

The ISDB-T method as the existing method can transmit OFDM frames by hierarchical transmission, which is simultaneous transmission of a group of OFDM segments which has been subjected to different transmission line encoding. In the hierarchical transmission, one channel is divided into one or more layers including one or more segments. Then, different transmission line encoding can be employed in each layer. It can be said that the new method that can broadcast using part of layers of the ISDB-T method as the existing method is compatible with the ISDB-T method as the existing method.

Broadcasting by the new method compatible with the ISDB-T method can be performed while maintaining broadcasting of the ISDB-T method.

In a case of introducing a new method that is compatible with the existing method, two phases are assumed. That is, the first phase is to introduce the new method while maintaining compatibility with the existing method, and the second phase is to stop the broadcasting service of the existing method and only operate the new method.

Then, upon introducing the new method, it is demanded that the new method is appropriately introduced, so that the new method reception device 20N or the dual reception device 20D can appropriately receive and process the broadcast signal of the new method without affecting operation of the existing method reception device 20L.

Therefore, in the present technology, as control information corresponding to introduction of the new method (second method) compatible with the existing method (first method), that is, control information to be newly introduced upon introduction of the new method, control information regarding segments which are division units in a frequency domain (hereinafter, also referred to as segment control information) is included in a TMCC signal (transmission control signal), and the transmission control signal including the segment control information is processed by the reception device 20, so that the new method can be introduced more appropriately.

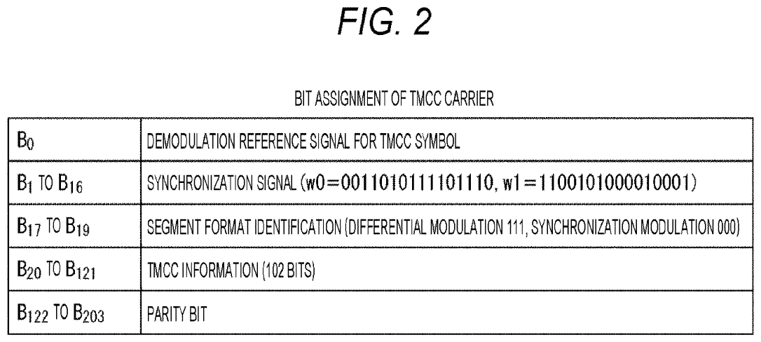

Hereinafter, upon introducing the new method compatible with the existing method, the present technology that uses the transmission control signal including the segment control information to more appropriately introduce the new method will be described in detail with reference to FIGS. 2 to 24.

Incidentally, in Japan, the Integrated Services Digital Broadcasting-Terrestrial (ISDB-T) method is employed as the existing method for terrestrial digital television broadcasting.

In this ISDB-T method, the frequency band of a plurality of subcarriers subjected to orthogonal frequency division multiplexing (OFDM) assigned to one channel (frequency band) is divided into thirteen segments. OFDM is a type of digital modulation in which multiplexing is performed by forming a plurality of different subcarriers in a certain frequency band and transmitting it at the same time.

Then, among the thirteen segments, twelve segments are used for broadcasting for fixed receivers, and the remaining one segment is used for broadcasting for mobile receivers (what is called one-segment broadcasting). Furthermore, data for broadcasting is transmitted simultaneously in these thirteen segments.

Note that one channel (frequency band) is divided into thirteen segments, but here, one channel can be configured by a maximum of three layers. These three layers can be, for example, an A layer including one segment, a B layer including six segments, and a C layer including six segments. However, the number of segments in each layer can be arbitrarily set as long as the total of segments of the three layers (A layer, B layer, C layer) does not exceed thirteen segments.

Furthermore, in the ISDB-T method, transmission multiplexing configuration control (TMCC) is defined as the transmission control signal. This TMCC signal includes information such as transmission parameters such as a modulation method of each layer and an error correction coding rate.

As the existing method, for example, a broadcasting method such as the above ISDB-T method that performs hierarchical transmission using layers including segments is assumed. Because a layer is constituted of segments, the segment control information regarding segments can also be regarded as hierarchical control information regarding the layers constituted of segments.

(Example of TMCC Signal)

FIG. 2 illustrates an example of bit allocation of a TMCC carrier.

FIG. 2 illustrates that, among 204 bits B₀ to B₂₀₃ of the TMCC carrier, a demodulation reference signal for TMCC symbol is assigned to the bit B₀, a synchronization signal is assigned to the bits B₁ to B₁₆, a segment format identification is assigned to the bits B₁₇ to B₁₉, TMCC information is assigned to the bits B₂₀ to B₁₂₁, and a parity bit is assigned to the bits B₁₂₂ to B₂₀₃.

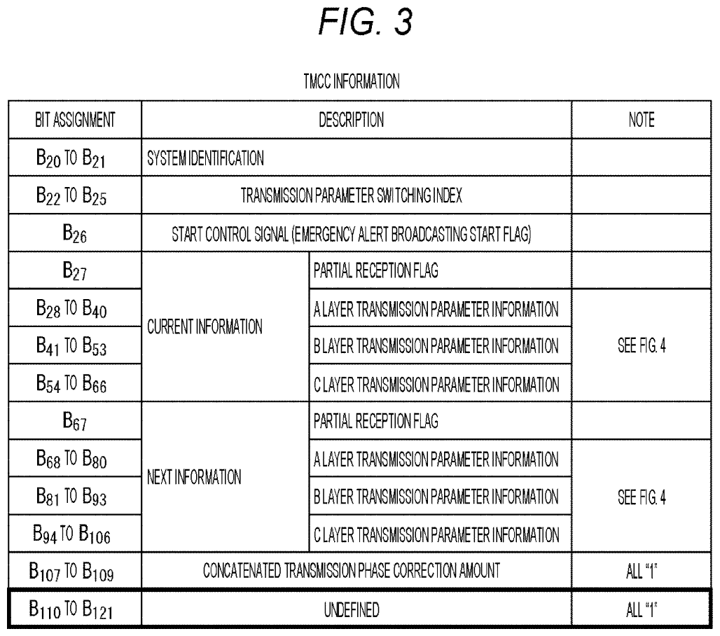

FIG. 3 illustrates details of the bits B₂₀ to B₁₂₁ of the TMCC information of FIG. 2.

Among the B₂₀ to B₁₂₁ of the TMCC information, system identification is assigned to the bits B₂₀ to B₂₁, a transmission parameter switching index is assigned to the bits B₂₂ to B₂₅, a start control signal is assigned to the bit B₂₆, current information is assigned to the bits B₂₇ to B₆₆, next information is assigned to the bits B₆₇ to B₁₀₆, a concatenated transmission phase correction amount is assigned to the bits B₁₀₇ to B₁₀₉, and the bits B₁₁₀ to B₁₂₁ are undefined.

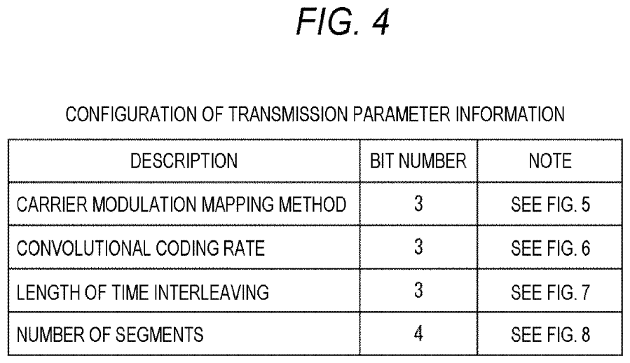

FIG. 4 illustrates an example of a configuration of transmission parameter information of each layer of the current information and the next information in the TMCC information of FIG. 3. That is, FIG. 4 illustrates the transmission parameter information of the A layer, the B layer, and the C layer of the current information, and the A layer, the B layer, and the C layer of the next information.

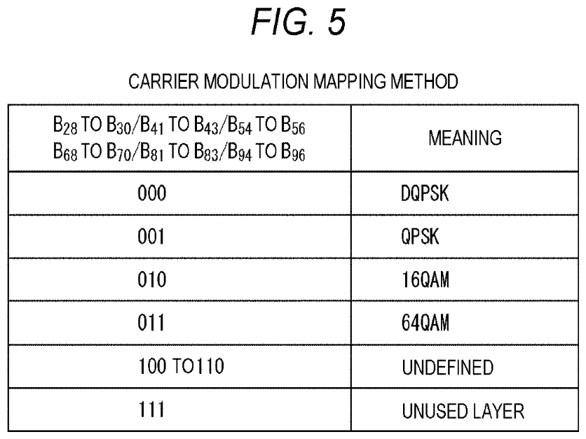

This transmission parameter information includes a carrier modulation mapping method of three bits, a convolutional coding rate of three bits, a length of time interleaving of three bits, and a number of segments of four bits. Here, FIGS. 5 to 8 illustrate specific examples of these pieces of transmission parameter information.

FIG. 5 illustrates an example of the carrier modulation mapping method. As this carrier modulation mapping method, for example, modulation methods such as differential quadrature phase shift keying (DQPSK), quadrature phase shift keying (QPSK), quadrature amplitude modulation (16QAM), 64QAM, or the like is specified according to 3-bit values ‘000’, ‘001’, ‘010’, and ‘011’.

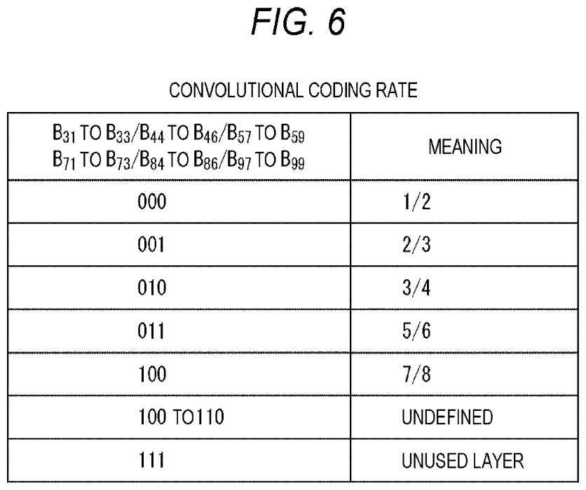

FIG. 6 illustrates an example of the convolutional coding rate. As this convolutional coding rate, for example, a coding rate of 1/2, 2/3, 3/4, 5/6, 7/8, or the like is specified according to the 3-bit values of ‘000’, ‘001’, ‘010’, ‘011’, and ‘100’.

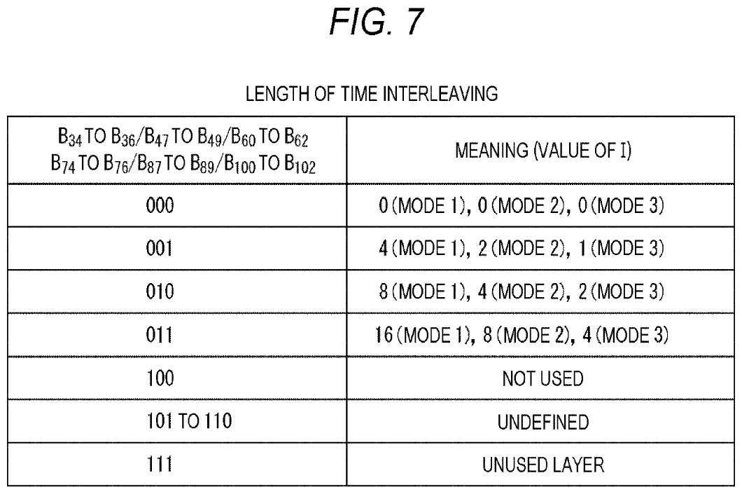

FIG. 7 illustrates an example of the length of the time interleaving. As the length of this time interleaving, for example, values of I in modes 1 to 3 are set according to the 3-bit values of ‘000’, ‘001’, ‘010’, and ‘011’, respectively.

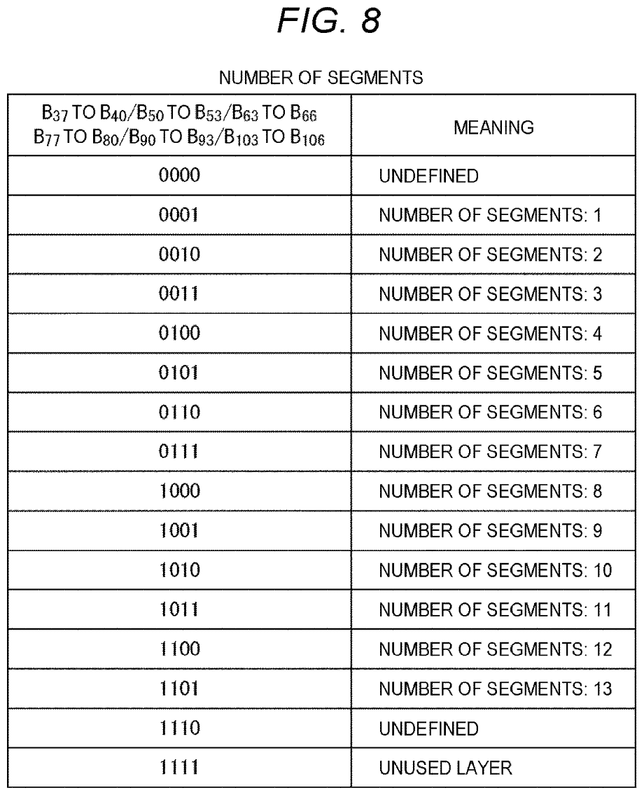

FIG. 8 illustrates an example of the number of segments. As the number of segments, for example, 1 to 13 are set as the number of segments according to 4-bit values of ‘0001’ to ‘1101’, respectively. A 4-bit value ‘1110’ as the number of segments is undefined, and a value ‘1111’ indicates that (the segments that constitute) the layer is unused.

The TMCC signal has the configuration as described above.

(Example of TMCC Signal to which Present Technology is Applied)

In the present technology, new method introduction control information and the segment control information are added to undefined bits (reserved bits) of the TMCC information included in the TMCC signal.

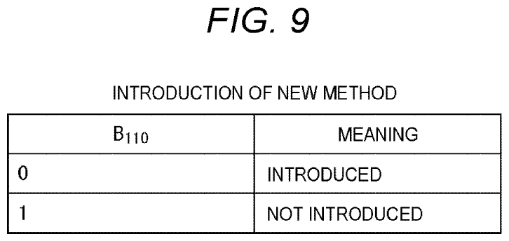

FIG. 9 illustrates an example of the new method introduction control information.

In FIG. 9, among the undefined bits of the TMCC information, the new method introduction control information is assigned to one bit of the bit B₁₁₀.

Here, in a case where ‘0’ is specified as the bit B₁₁₀ of the TMCC information, this indicates that a new method compatible with the existing method has been introduced. On the other hand, in a case where ‘1’ is specified as the bit B₁₁₀ of the TMCC information, this indicates that no new method compatible with the existing method has been introduced.

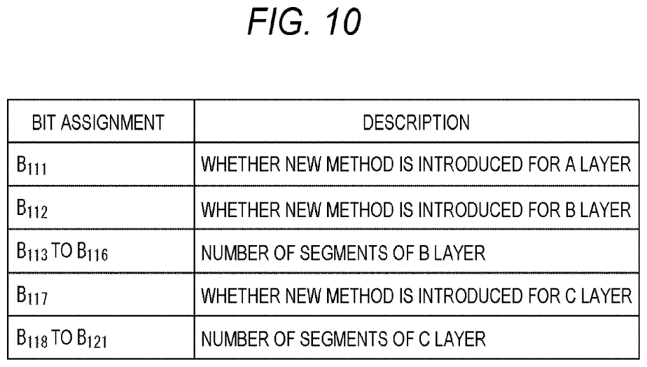

FIG. 10 illustrates an example of the segment control information.

FIG. 10 illustrates the segment control information assigned to the bits B₁₁₁ to B₁₂₁ excluding the bit B₁₁₀ among the undefined bits of the TMCC information in FIG. 3.

That is, among the undefined bits B₁₁₁ to B₁₂₁ of the TMCC information, whether or not a new method is introduced for the A layer is assigned to the bit B₁₁₁, whether or not a new method is introduced for the B layer is assigned to B₁₁₂, the number of segments of a new method for the B layer is assigned to the bits B₁₁₃ to B₁₁₆, whether or not a new method is introduced for the C layer is assigned to the bit B₁₁₇, and the number of segments of a new method for the C layer is assigned to the bits B₁₁₇ to B₁₂₁.

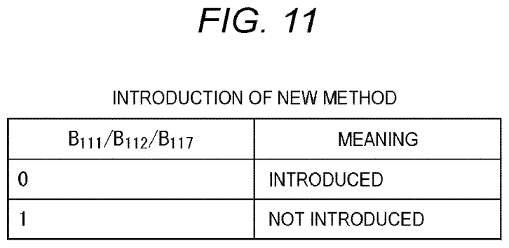

FIG. 11 illustrates an example of whether or not a new method is introduced for each layer.

In FIG. 11, in a case where ‘0’ is specified as bit B₁₁₁ of the TMCC information, this indicates that a new method has been introduced in the A layer, and in a case where ‘1’ is specified, this indicates that no new method has been introduced for the A layer.

Similarly, in a case where ‘0’ is specified as the bits B₁₁₂ and B₁₁₇ of the TMCC information, this indicates that a new method has been introduced in the B layer and the C layer, and in a case where ‘1’ is specified as the bits B₁₁₂ and B₁₁₇, this indicates that no new method has been introduced for the B layer and the C layer.

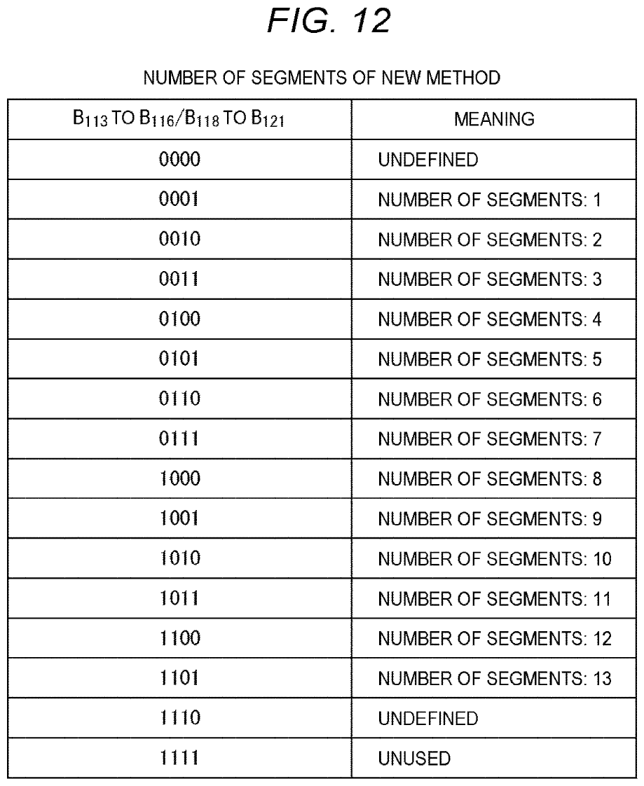

FIG. 12 illustrates an example of the number of segments of the new method in the B layer or the C layer.

In FIG. 12, as the 4-bit values of the bits B₁₁₃ to B₁₁₆, the number of segments in the B layer is one in a case where ‘0001’ is specified, the number of segments in the B layer is two in a case where ‘0010’ is specified, and the number of segments in the B layer is three in a case where ‘0011’ is specified.

Thereafter, similarly, in a case where ‘0100’ to ‘1101’ are specified as the 4-bit values of the bits B₁₁₃ to B₁₁₆, this indicates that the number of segments in the B layer is four to thirteen, respectively. Furthermore, similarly, in a case where ‘0001’ to ‘1101’ are specified as the 4-bit values of the bits B₁₁₈ to B₁₂₁, this indicates that the number of segments in the C layer is one to thirteen, respectively. As a 4-bit value of the bits B₁₁₃ to B₁₁₆, ‘1110’ is undefined, and ‘1111’ indicates that (the segments constituting) the layer is unused.

Here, because it can be determined from the number of segments that the layer is unused, in the present technology, items excluding the number of segments from the hierarchical transmission parameter information of the current information in the existing TMCC information can be used to indicate the transmission parameter (modulation parameter) of the new method.

That is, in the reception device 20, whether or not the A layer is unused by the existing method can be determined by whether or not the 4-bit value as the number of segments constituting the transmission parameter information (FIG. 8) of the A layer of the current information is ‘1111’. In a case where it is determined that the A layer is unused by the existing method, the existing method reception device 20L does not refer to other items (items other than the number of segments) of the transmission parameter information of the existing method in the A layer. Therefore, in a case where the A layer is unused by the existing method, regardless of what are the items other than the number of segments of the transmission parameter information of the existing method in the A layer, (operation of) the existing method reception device 20L is not affected.

From the above, in a case where the A layer is unused by the existing method, items other than the number of segments of the transmission parameter information of the existing method of the A layer can be freely used, for example, can be used for indicating the transmission parameter of the new method. The above point similarly applies to the transmission parameter information of the B layer and the C layer other than the A layer.

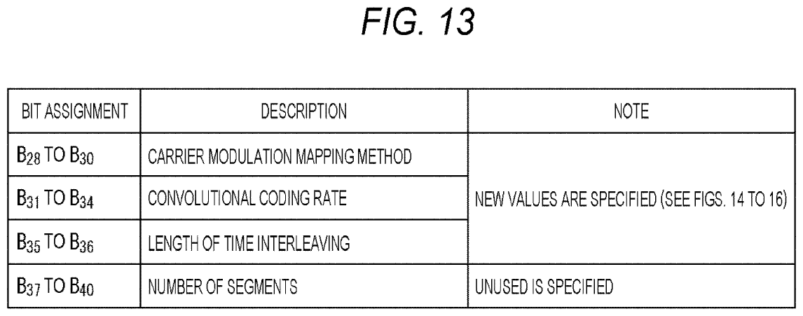

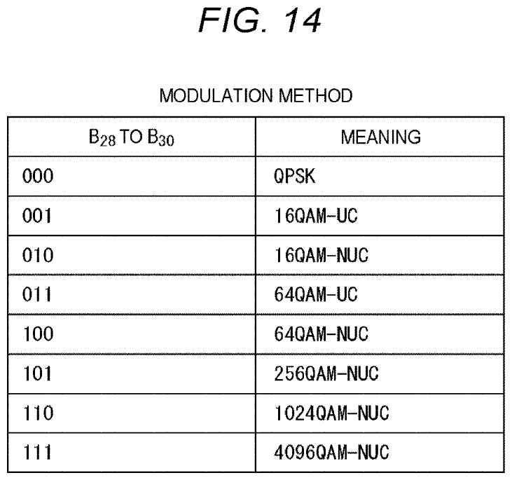

FIG. 13 illustrates an example of a configuration of A layer hierarchical transmission parameter information in the current information of the TMCC information. Here, the description will be given with reference to specific examples of FIGS. 14 to 16 as appropriate. However, information regarding the modulation method, the coding rate, and the time interleaving is an example, and other transmission parameters may be indicated.

That is, as the modulation method assigned to the bits B₂₈ to B₃₀ among the bits B₂₈ to B₄₀ of the A layer hierarchical transmission parameter information, for example, the modulation method illustrated in FIG. 14 can be newly specified as the transmission parameter of the new method.

This modulation method includes, for example, QPSK, 16QAM-UC, 16QAM-NUC, 64QAM-UC, 64QAM-NUC, 256QAM-NUC, 1024QAM-NUC, 4096QAM-NUC, and the like are specified according to the 3-bit values of ‘000’, ‘001’, ‘010’, ‘011’, ‘100’, ‘101’, ‘110’, and ‘111’.

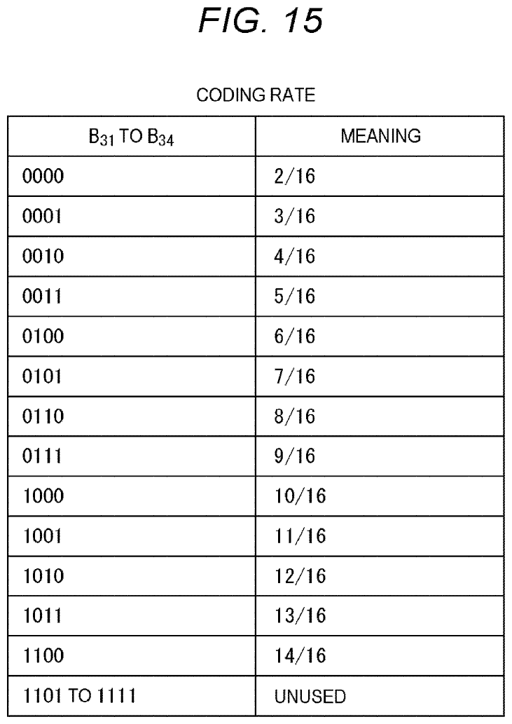

Furthermore, as the coding rate assigned to the bits B₃₃ to B₃₄ among the bits B₂₈ to B₄₀ of the A layer hierarchical transmission parameter information, for example, the coding rate illustrated in FIG. 15 can be newly specified as the transmission parameter of the new method.

As the coding rate, for example, coding rates 2/16, 3/16, 4/16, 5/16, 6/16, 7/16, 8/16, 9/16, 10/16, 11/16, 12/16, 13/16, 14/16, or the like is specified according to the 4-bit values of ‘0000’, ‘0001’, ‘0010’, ‘0011’, ‘0100’, ‘0101’, ‘0110’, ‘0111’, ‘1000’, ‘1001’, ‘1010’, ‘1011’, and ‘1100’.

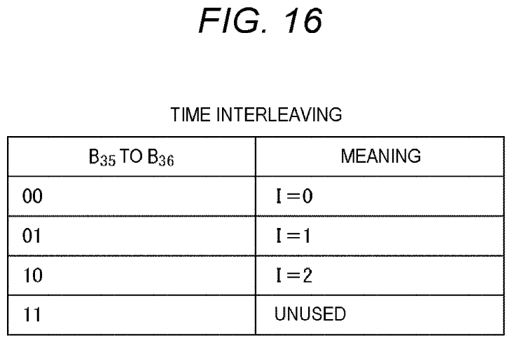

Moreover, as the length of the time interleaving assigned to the bits B₃₅ to B₃₆ among the bits B₂₉ to B₄₀ of the A layer hierarchical transmission parameter information, for example, the length of the time interleaving illustrated in FIG. 16 can be specified as the transmission parameter of the new method.

As the length of this time interleaving, for example, values I of I=0, 1, 2, or the like are set according to the 2-bit values of ‘00’, ‘01’, and ‘10’, respectively.

To summarize the above, in the present technology, the new method introduction control information and the segment control information are added to the undefined bits (reserved bits) of the TMCC information included in the TMCC signal. Specifically, the contents of the new method introduction control information and the segment control information are as follows.

(a) New method introduction control information
Bit B₁₁₀: this indicates whether or not a new method is introduced for the existing method.

‘0’: new method has been introduced

‘1’: no new method has been introduced

(b) Segment control information
Bit B₁₁₁: this indicates whether or not a new method is introduced for the A layer.

‘0’: new method has been introduced in the A layer

‘1’: no new method has been introduced in the A layer
Bit B₁₁₂: this indicates whether or not a new method is introduced for the B layer.

‘0’: new method has been introduced in the B layer

‘1’: no new method has been introduced in the B layer
Bits B₁₁₃ to B₁₁₆: these indicate the number of segments of a new method in the B layer.
Bit B₁₁₇: this indicates whether or not a new method has been introduced for the C layer.

‘0’: new method has been introduced in the C layer

‘1’: no new method has been introduced in the C layer
Bits B₁₁₈ to B₁₂₁: these indicate the number of segments of a new method in the C layer.

In this manner, by newly defining the new method introduction control information (bit B₁₁₀) and the segment control information (bits B₁₁₁ to B₁₂₁) in the TMCC information, the reception device 20 can determine whether or not a new method has been introduced with respect to the existing method on the basis of the new method introduction control information. Furthermore, the reception device 20 can perform a process (demodulation process regarding the segments) according to the segment control information in a case where it is determined that the new method has been introduced with respect to the existing method.

Thus, for example, in the new method reception device 20N or the dual reception device 20D, in a case where ‘0’ is specified as the value of the bit B₁₁₀ and it is determined that the new method is introduced, a process according to the segment control information (values of the bits B₁₁₁ to B₁₂₁) is performed. Therefore, the new method reception device 20N or the dual reception device 20D can appropriately receive and process the broadcast signal of the new method without affecting operation of the existing method reception device 20L.

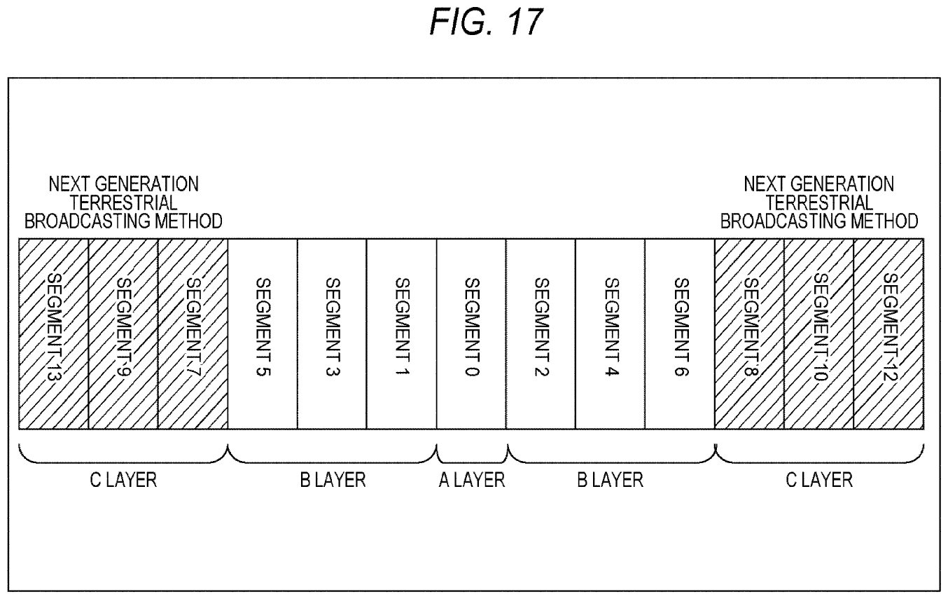

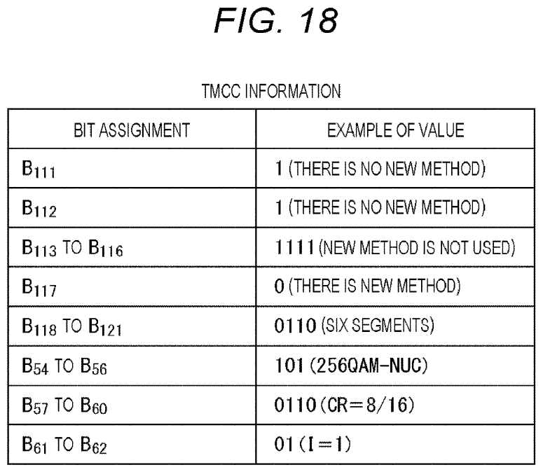

(Specific example of segment control information) Here, with reference to FIGS. 17 and 18, specific examples of the segment control information (bits B₁₁₁ to B₁₂₁) included in the TMCC information will be described.

In FIG. 17, among the thirteen segments, the A layer and the B layer, that is, the central one segment and three segments on the left and right, are used for the existing method (ISDB-T method), and the C layer, that is, three segments further outside the segments on the left and right of the B layer are used for the new method (next generation terrestrial broadcasting method).

That is, in the example of the segment configuration in FIG. 17, a total of seven segments of the A layer and the B layer are used for the existing method, and six segments of the C layer are used for the new method. Note that it can be said that the next-generation terrestrial broadcasting method is also the next-generation method of the ISDB-T method.

At this time, in the segment control information (bits B₁₁₁ to B₁₂₁) included in the TMCC information, for example, a value as illustrated in FIG. 18 is specified.

That is, in the segment configuration of FIG. 17, because the A layer and the B layer are used for the existing method, ‘1’ indicating that no new method has been introduced for the A layer is specified as the bit B₁₁₁ (FIG. 10), and ‘1’ indicating that no new method has been introduced for the B layer is specified as the bit B₁₁₂ (FIG. 10). At this time, because the B layer is unused in the new method, ‘1111’ indicating that the segment of the B layer is unused is specified as the bits B₁₁₃ to B₁₁₆ (FIG. 10).

Furthermore, in the segment configuration of FIG. 17, because the C layer is used for the new method, ‘0’ indicating that the new method has been introduced in the C layer is specified as the bit B₁₁₇ (FIG. 10). Furthermore, at this time, since six segments of the C layer are used in the new method, ‘0110’ indicating that the number of segments is six is specified as the bits B₁₁₈ to B₁₂₁ (FIG. 10).

In a case where the C layer is used (used) by the new method, because the C layer is not used in the existing method, as the bits B₆₃ to B₆₆, which represent the number of segments (FIG. 8) constituting the transmission parameter information (FIG. 4) of the C layer of the current information, ‘1111’ indicating that they are unused in the existing method is specified.

In this case, because the existing method reception device 20L does not refer to items other than the number of segments for the transmission parameter information of the current information of the C layer, among the bits B₅₄ to B₆₆ representing the transmission parameter information of the current information of the C layer (FIG. 3), the bits B₅₄ to B₆₂ (FIG. 4) other than the bits B₆₃ to B₆₆ representing the number of segments can be used to indicate the transmission parameters of the new method.

Here, the bits B₅₄ to B₆₂ are assigned to the modulation method, the coding rate, and the length of the time interleaving used in the new method as described with reference to FIG. 13.

Specifically, ‘101’ is specified as the bits B₅₄ to B₅₆ because 256QAM-NUC is used as the modulation method of the new method. Furthermore, ‘0110’ is specified as the bits B₅₇ to B₆₀ because CR=8/16 is used as the coding rate (convolutional coding rate) of the new method. Moreover, ‘01’ is specified as the bits B₆₂ to B₆₂ because I=1 is used as the length of the time interleaving of the new method.

In this manner, because the segment control information (bits B₁₁₁ to B₁₂₁) corresponding to the segment configuration is specified in the TMCC information, even in a case where the new method is introduced, the reception device 20 can appropriately perform the process according to the segment configuration on the basis of the segment control information (bits B₁₁₁ to B₁₂₁).

(Configuration of Transmission Device)

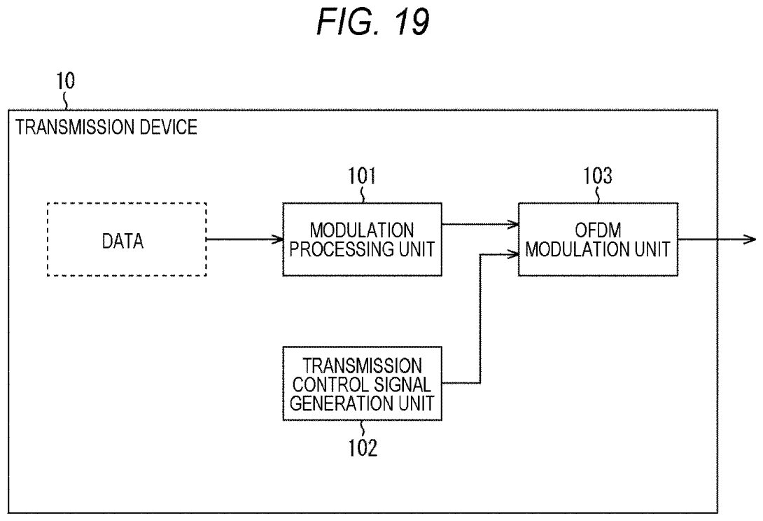

FIG. 19 illustrates an example of a configuration of the transmission device 10 of FIG. 1.

In FIG. 19, the transmission device 10 includes a modulation processing unit 101, a transmission control signal generation unit 102, and an OFDM modulation unit 103.

The modulation processing unit 101 performs a modulation process on data of broadcast content input therein as transmission data, and supplies a data signal obtained as a result to the OFDM modulation unit 103.

This modulation process includes, for example, forward error correction coding modulation process (error correction coding process), a process related to layers (for example, A layer, B layer, C layer, or the like), processes such as time interleaving, frequency interleaving, and the like.

The transmission control signal generation unit 102 generates the TMCC signal as the transmission control signal and supplies the TMCC signal to the OFDM modulation unit 103.

The OFDM modulation unit 103 is (a part of) a transmission unit that performs a process related to the OFDM frame as a transmission frame. The OFDM modulation unit 103 performs an OFDM modulation process on the data signal supplied from the modulation processing unit 101 and the TMCC signal supplied from the transmission control signal generation unit 102, and transmits (sends out) a modulation signal obtained as a result via the transmission antenna (not illustrated) as a broadcast signal.

This OFDM modulation process includes, for example, a configuration of the OFDM frame, an inverse fast Fourier transform (IFFT) that converts a frequency domain signal into a time domain signal, and a process to add a guard interval (GI), or the like.

The transmission device 10 is configured as described above.

Note that, here, although the existing method and the new method have been described by not particularly distinguishing here for simplification of the description, the modulation processing unit 101, the transmission control signal generation unit 102, and the OFDM modulation unit 103 correspond to both methods and can send out, for example, the broadcast signal according to the segment configuration illustrated in FIG. 17.

For example, in the existing method, 2K content corresponding to 2K video is processed as broadcast content and the broadcast signal (2K broadcast signal) thereof is sent out, while in the new method, 4K content corresponding to 4K video is processed as broadcast content and the broadcast signal (4K broadcast signal) thereof is sent out.

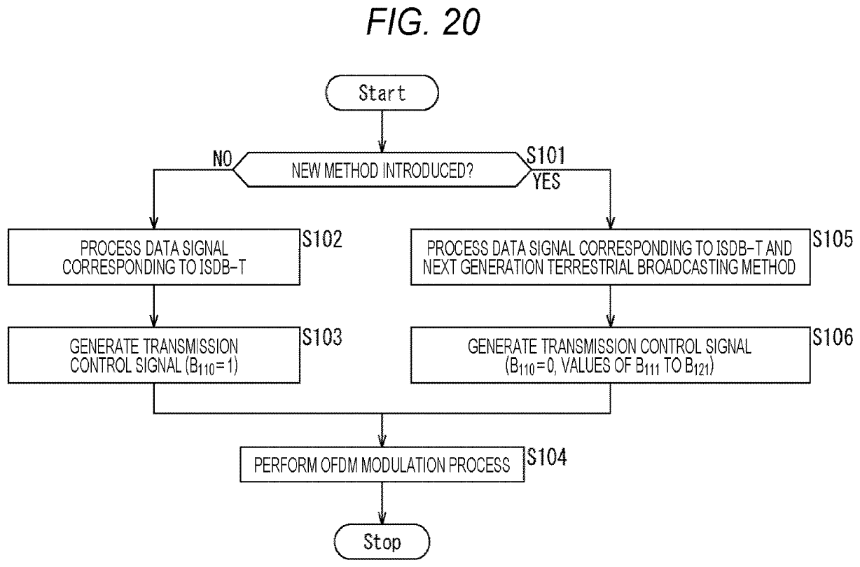

Next, a flow of a transmission process executed by the transmission device 10 will be described with reference to a flowchart of FIG. 20.

In a determination process of step S101, it is determined whether or not a new method has been introduced with respect to the existing method. However, this example illustrates a case where the existing method is the ISDB-T method and the new method is the next-generation terrestrial broadcasting method.

In a case where it is determined in the determination process of step S101 that the new method has not been introduced, the process proceeds to step S102, and processing of steps S102 to S104 is executed.

That is, the modulation processing unit 101 processes the data signal corresponding to the ISDB-T method (S102). In processing of this data signal, for example, the forward error correction coding modulation process, a process related to layers, processes such as time interleaving, frequency interleaving, and the like are performed on 2K content data.

Furthermore, the transmission control signal generation unit 102 generates a TMCC signal (S103). For example, in this TMCC signal, ‘1’ is specified as the bit B₁₁₀ in the new method introduction control information included in the TMCC information, indicating that no new method has been introduced.

When processing of steps S102 and S103 is finished, the process proceeds to step S104. Then, the OFDM modulation unit 103 performs the OFDM modulation process on the signals obtained in the processing of steps S102 and S103 (S104). Thus, a modulation signal obtained as a result of the OFDM modulation process is transmitted as the broadcast signal (2K broadcast signal).

On the other hand, in a case where it is determined in the determination process of step S101 that the new method has been introduced, the process proceeds to step S105, and processing of steps S105 to S106 and S104 is executed.

That is, the modulation processing unit 101 processes the data signal corresponding to the ISDB-T method and the next-generation terrestrial broadcasting method (S105). In processing of this data signal, for example, the forward error correction coding modulation process, a process related to layers, processes such as time interleaving, frequency interleaving, and the like are performed on 2K content data and 4K content data.

Furthermore, the transmission control signal generation unit 102 generates the TMCC signal (S106). For example, in this TMCC signal, ‘0’ is specified as the bit B₁₁₀ in the new method introduction control information included in the TMCC information to indicate that the new method has been introduced, and each value of the segment control information (bits B₁₁₁ to B₁₂₁) is also specified.

When processing of steps S105 and S106 is finished, the process proceeds to step S104. Then, the OFDM modulation unit 103 performs the OFDM modulation process on the signal obtained in the processing of steps S105 and 106 (S104). Thus, a modulation signal obtained as a result of the OFDM modulation process is transmitted as the broadcast signal (2K, 4K broadcast signal).

The flow of the transmission process has been described above.

Note that, here, the first phase of introducing the new method while maintaining compatibility with the existing method has been described as the phase after the introduction of the new method, but in a case of the second phase in which the existing broadcasting service is stopped and only the new broadcasting service is operated, only data of the 4K content is processed and only the 4K broadcast signal is transmitted in the processing of steps S105 to S106 and S104 after the determination process of step S101.

(Configuration of Reception Device)

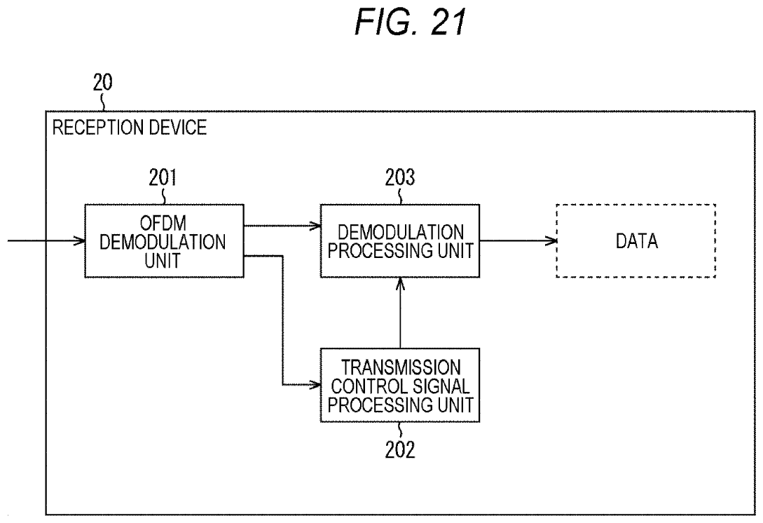

FIG. 21 illustrates an example of a configuration of the reception device 20 of FIG. 1.

In FIG. 21, the reception device 20 includes an OFDM demodulation unit 201, a transmission control signal processing unit 202, and a demodulation processing unit 203.

The OFDM demodulation unit 201 is (a part of) a reception unit that performs processing related to the OFDM frame as a transmission frame. The OFDM demodulation unit 201 performs an OFDM demodulation process on the broadcast signal received via the receiving antenna (not illustrated), and supplies a demodulation signal obtained as a result to the transmission control signal processing unit 202 and the demodulation processing unit 203.

This OFDM demodulation process includes, for example, a process of removing a guard interval (GI), a fast Fourier transform (FFT) of converting a time domain signal into a frequency domain signal, a process of demodulating the OFDM frame, and the like.

The transmission control signal processing unit 202 performs a TMCC demodulation and decoding process on the demodulation signal supplied from the OFDM demodulation unit 201, and supplies the TMCC information included in the TMCC signal obtained as a result to the demodulation processing unit 203.

The demodulation processing unit 203 performs a demodulation process on the data signal obtained from the demodulation signal supplied from the OFDM demodulation unit 201 on the basis of the TMCC information supplied from the transmission control signal processing unit 202, and outputs an output signal obtained as a result to a subsequent circuit (for example, a decoder or the like).

The demodulation process includes, for example, frequency deinterleaving, time deinterleaving, processing related to layers (for example, A layer, B layer, C layer, and the like), a forward error correction demodulation decoding process (process of decoding an error correction code), and the like.

The reception device 20 is configured as described above.

Note that, here, although the existing method reception device 20L, the new method reception device 20N, and the dual reception device 20D have been described without any particular distinction, each of the OFDM demodulation unit 201, the transmission control signal processing unit 202, and the demodulation processing unit 203 corresponding to specifications of the existing method is provided in the existing method reception device 20L, and each of the OFDM demodulation unit 201, the transmission control signal processing unit 202, and the demodulation processing unit 203 corresponding to specifications of the new method is provided in the new method reception device 20N.

Furthermore, as the OFDM demodulation unit 201, the transmission control signal processing unit 202, and the demodulation processing unit 203, ones corresponding to the specifications of the existing method and the specifications of the new method are provided in the dual reception device 20D.

With such a configuration, for example, in the first phase described above, the existing method reception device 20L receives the broadcast signal (2K broadcast signal) of the existing method and displays 2K video corresponding to 2K content. On the other hand, the new method reception device 20N or the dual reception device 20D receives the broadcast signal (4K broadcast signal) of the new method and displays 4K video according to 4K content.

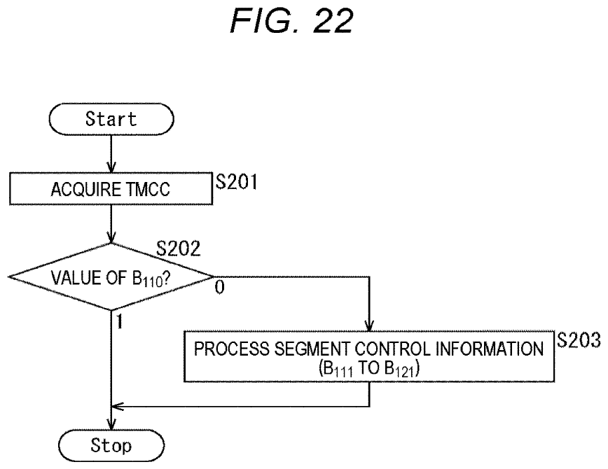

Next, the flow of the reception process executed by the reception device 20 will be described with reference to the flowcharts of FIGS. 22 and 23.

Here, first, an example of operation of the reception device 20 corresponding to the new method introduction control information (bit B₁₁₀) included in the TMCC information will be described with reference to the flowchart of FIG. 22.

In step S201, the transmission control signal processing unit 202 acquires the TMCC information (including new method introduction control information) from an OFDM demodulation result by the OFDM demodulation unit 201. Then, the subsequent processing is executed according to the new method introduction control information included in this TMCC information.

In the determination process of step S202, the value of the bit B₁₁₀ is determined. In a case where it is determined in the determination process of step S202 that the value of the bit Belo as the new method introduction control information is ‘0’, that is, it is determined that the new method is introduced, the process proceeds to step S203.

In step S203, the demodulation processing unit 203 processes the segment control information. In the process of this segment control information, whether or not a new method is introduced is determined for every layer on the basis of the segment control information (values of the bits B₁₁₁ to B₁₂₁), and processing such as demodulation based on the number of segments is performed according to a determination result thereof.

Note that in a case where it is determined in the determination process of step S202 that the value of the bit B₁₁₀ is ‘1’, that is, no new method has been introduced, processing of step S203 is skipped.

In this manner, the reception device 20 can determine whether or not the new method has been introduced with respect to the existing method on the basis of the new method introduction control information (bit B₁₁₀), and execute processing according to a determination result thereof.

Next, referring to a flowchart of FIG. 23, a process corresponding to the process of step S203 of FIG. 22, that is, an example of operation of the reception device 20 corresponding to the segment control information (values of bits B₁₁₁ to B₁₂₁) included in the TMCC information will be described.

However, in this example, a case where the existing method is the ISDB-T method and the new method is the next-generation terrestrial broadcasting method is exemplified.

In step S231, the transmission control signal processing unit 202 acquires the TMCC information (including the segment control information) included in the TMCC signal from the OFDM demodulation result by the OFDM demodulation unit 201. Then, processing of steps S232 to S240 is executed according to the segment control information (values of the bits B₁₁₁ to B₁₂₁) included in the TMCC information.

In the determination process of step S232, it is determined whether the value of the bit B₁₁₁ is ‘0’ or ‘1’.

In a case where it is determined in the determination process of step S232 that the value of the bit B₃₃₃ is ‘1’, the process proceeds to step S233. In step S233, the demodulation processing unit 203 demodulates the broadcast signal of the ISDB-T method with the 4-bit values (FIG. 8) of the bits B₃₇ to B₄₀ being the number of segments in the A layer.

Furthermore, in a case where it is determined in the determination process of step S232 that the value of the bit B₁₁₁ is ‘0’, the process proceeds to step S234. In step S234, the demodulation processing unit 203 demodulates the broadcast signal of the next-generation terrestrial broadcasting method with the 4-bit values (FIG. 8) of the bits B₃₇ to B₄₀ being the number of segments in the A layer.

When processing of step S233 or S234 is finished, the process proceeds to step S235. In the determination process of step S235, it is determined whether the value of the bit B₁₁₂ is ‘0’ or ‘1’.

In a case where it is determined in the determination process of step S235 that the value of the bit B₁₁₂ is ‘1’, the process proceeds to step S236. In step S236, the demodulation processing unit 203 demodulates the broadcast signal of the ISDB-T method with the 4-bit values (FIG. 8) of the bits B₅₀ to B₅₃ being the number of segments in the B layer.

Furthermore, in a case where it is determined in the determination process of step S235 that the value of the bit B₁₁₂ is ‘0’, the process proceeds to step S237. In step S237, the demodulation processing unit 203 demodulates the broadcast signal of the new next-generation terrestrial broadcasting method with the 4-bit values (FIG. 12) of the bits B₁₁₃ to B₁₁₆ being the number of segments in the B layer.

When processing of step S236 or S237 is finished, the process proceeds to step S238. In the determination process of step S238, it is determined whether the value of the bit B₁₁₇ is ‘0’ or ‘1’.

In a case where it is determined in the determination process of step S238 that the value of the bit B₁₁₇ is ‘1’, the process proceeds to step S239. In step S239, the demodulation processing unit 203 demodulates the broadcast signal of the ISDB-T method with the 4-bit values (FIG. 8) of the bits B₆₃ to B₆₆ being the number of segments in the C layer.

Furthermore, in a case where it is determined in the determination process of step S238 that the value of the bit B₁₁₇ is ‘0’, the process proceeds to step S240. In step S240, the demodulation processing unit 203 demodulates the broadcast signal of the next-generation terrestrial broadcasting method with the 4-bit values (FIG. 12) of the bits B₁₁₃ to B₁₂₁ being the number of segments in the C layer.

When processing of step S239 or S240 is finished, the process illustrated in FIG. 23 is finished.

The flow of reception processing has been described above.

(Example of Other Applications)

Note that in the above description, thirteen segments are exemplified as the number of segments which are the division units in the frequency domain, but the number of segments is not limited to thirteen and, for example, can be any number such as thirty five segments further subdivided than the existing ones. Furthermore, in the above description, one channel has been described as including the maximum of three layers (A layer, B layer, C layer), but the number of layers is not limited to three layers and, for example, can be any number of layers such as two layers or four layers or more.

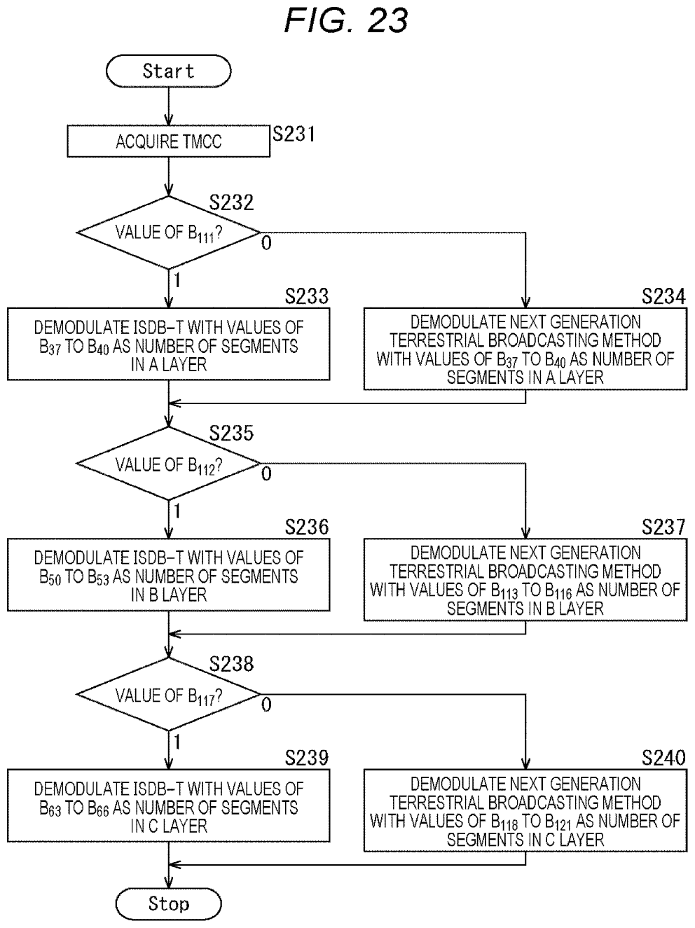

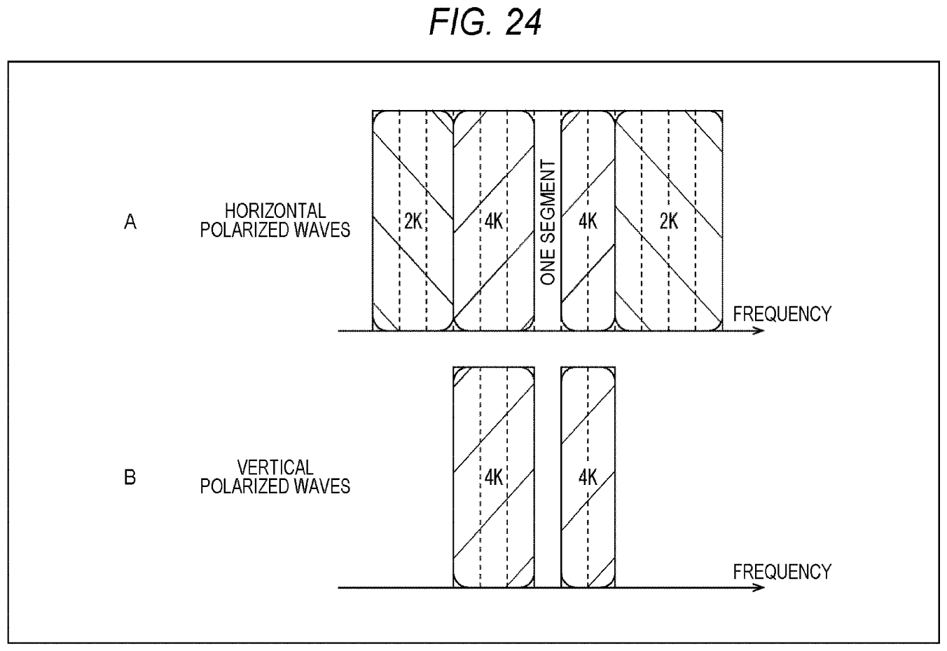

Furthermore, in a case where a new method that is compatible with the existing method is introduced, it is assumed that a multiple input multiple output (MIMO) method that uses a plurality of antennas for transmission and reception is employed for transmitting the broadcast signal of the existing method and the broadcast signal of the new method. FIG. 24 schematically illustrates transmission of the MIMO method.

In FIG. 24, because the MIMO method is used, the broadcast signal (2K broadcast signal) of the existing method and the broadcast signal (4K broadcast signal) of the new method are transmitted by horizontal polarized waves (A in FIG. 24), and the broadcast signal (4K broadcast signal) of the new method is transmitted by vertical polarized waves (B in FIG. 24).

Even in a case where transmission of such MIMO method is used, for example, by including the segment control information (and the new method introduction control information) in the TMCC signal transmitted by horizontal polarized waves, and causing the transmission control signal including this segment control information (and the new method introduction control information) to be processed by the reception device 20, it is possible to more appropriately introduce the new method.

(Another Embodiment of Segment Control Information)

Hereinafter, another embodiment of the segment control information, that is, an embodiment of the segment control information in a case where the MIMO method can be used for introducing the new method will be described.

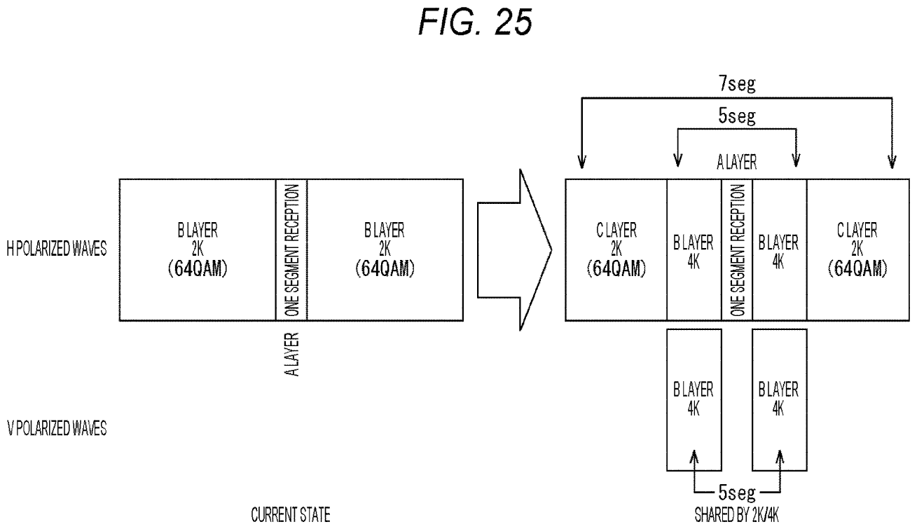

FIG. 25 is a diagram describing an introduction method for introducing the new method while maintaining the broadcasting of the ISDB-T method as the existing method.

The introduction method of FIG. 25 is one of introduction methods of the new method introduced in “Research and Development on Advanced Broadcasting”, Mar. 16, 2018, Ministry of Internal Affairs and Communications Information and Distribution Administration Bureau, NHK, Kansai Telecasting Corporation, TBS Television (http://www.soumu.go.jp/main_content/000539299.pdf) (hereinafter referred to as Reference 1).

In the introduction method of FIG. 25, the new method is introduced using the MIMO (Multiple Input Multiple Output) method in which H polarized waves (horizontal polarized waves) and V polarized waves (vertical polarized waves) are received by a plurality of respective corresponding antennas.

In the current (current state) ISDB-T method, one channel having thirteen segments is divided into two layers, an A layer constituted of one segment and a B layer constituted of twelve segments. Then, one-segment broadcasting is performed with the A layer, and what is called 2K broadcasting is performed with the B layer. Furthermore, in the one-segment broadcasting and the 2K broadcasting, only the H polarized waves are used in a single-input single-output (SISO) method.

In a case of introducing the new method, one channel is divided into three layers, for example, the A layer constituted of one segment, the B layer constituted of five segments, and the C layer constituted of seven segments.

Then, for example, in the A layer, one-segment broadcasting is performed by the H polarized waves, and in the C layer, the 2K broadcasting is performed by the H polarized waves.

Moreover, for example, in the B layer, as a new method of broadcasting, for example, the 4K broadcasting is performed by the MIMO method using the H polarized waves and the V polarized waves.

Here, the 2K broadcasting is broadcasting of video corresponding to a screen resolution of approximately 1920×1080 pixels, and the 4K broadcasting is broadcasting of video corresponding to a screen resolution of approximately 3840×2160 pixels.

Furthermore, as the new method of broadcasting, in addition to the 4K broadcasting, it is possible to broadcast higher quality video such as 8K broadcasting, for example. The 8K broadcasting is a method of video that supports screen resolutions of approximately 7680×4320 pixels.

Incidentally, in the reception device 20, in a case where the SISO method is used, it is only required to receive the H polarized waves, but in a case where the MIMO method is used, it is necessary to receive not only the H polarized waves but also the V polarized waves. Therefore, in a case where the MIMO method is used for introduction of the new method, it is necessary to replace the antenna in the reception device 20 (and the transmission device 10) so that both the H polarized waves and the V polarized waves can be received.

Because the replacement of antennas has a large economic influence, it is conceivable that the SISO method will be used instead of the MIMO method for introduction of the new method. As a method of introducing a new method using the SISO method, for example, there is a method of using layered division multiplexing (LDM).

As described above, both the SISO method and the MIMO method can be used upon introduction of the new method. Therefore, it is desirable to be able to deal with the introduction of the new method regardless of whether the SISO method or the MIMO method is used.

Hereinafter, the segment control information that can cope with a case where both the SISO method and the MIMO method can be used for introduction of the new method will be described.

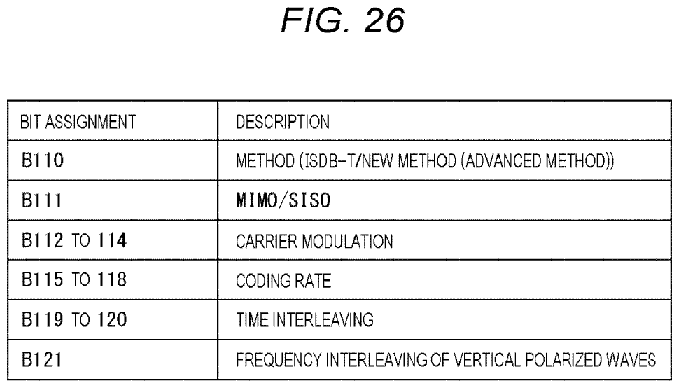

FIG. 26 is a diagram describing an example of the segment control information in a case where the MIMO method can be used for introducing the new method.

Note that, here, for simplicity of description, the introduction of the new method will be performed only for the B layer. That is, the ISDB-T method as the existing method can be performed in the A layer, the B layer, and the C layer, and the new method (an advanced method that is an advanced version of the ISDB-T method) can be performed in the B layer.

In FIG. 26, the segment control information regarding the segments constituting the B layer is assigned to the undefined bits B110 to B121 of the TMCC information in FIG. 3. By assigning the segment control information regarding the segments constituting the B layer to the undefined bits B110 to B121 of the TMCC information, in the new method reception device 20N and the dual reception device 20D, it is possible to receive broadcasts of the new method without affecting reception of broadcasts of the existing method by the existing method reception device 20L and the dual reception device 20D.

In FIG. 26, of the bits B110 to B121 as the segment control information, information representing that broadcasting performed in the B layer is broadcasting of the ISDB-T method as the existing method or the new method is assigned to the bit B110, information indicating that broadcasting of the new method performed in the B layer is broadcasting using the SISO method or the MIMO method is assigned to the bit B111, information representing a carrier modulation (mapping) method of the new method is assigned to the bits B112 to B114, information indicating a coding rate of the new method is assigned to the bits B115 to B118, information indicating a length of time interleaving of the new method is assigned to the bits B119 to B120, and information indicating that frequency interleaving on the V polarized wave side of broadcasting of the new method using the MIMO method, which is performed in the B layer, is intralayer interleaving or interlayer interleaving is assigned to the bit B121.

Note that the new method can also be introduced in the A layer and the C layer other than the B layer. In a case where the new method can be introduced in all of the A, B, and C layers, in addition to the segment control information regarding (the segments that constitute) the B layer, it is necessary to prepare segment control information similar to that in FIG. 26 as the segment control information regarding (the segments that constitute) each of the A layer and the C layer.

The segment control information regarding (the segments constituting) each of the A layer and the C layer can be assigned instead of the parity bit to part of the bits B122 to B203 to which the parity bit of the TMCC signal is assigned, for example, on the condition that the error detection of the TMCC signal (carrier) in FIG. 2 is omitted when receiving broadcasts of the existing method.

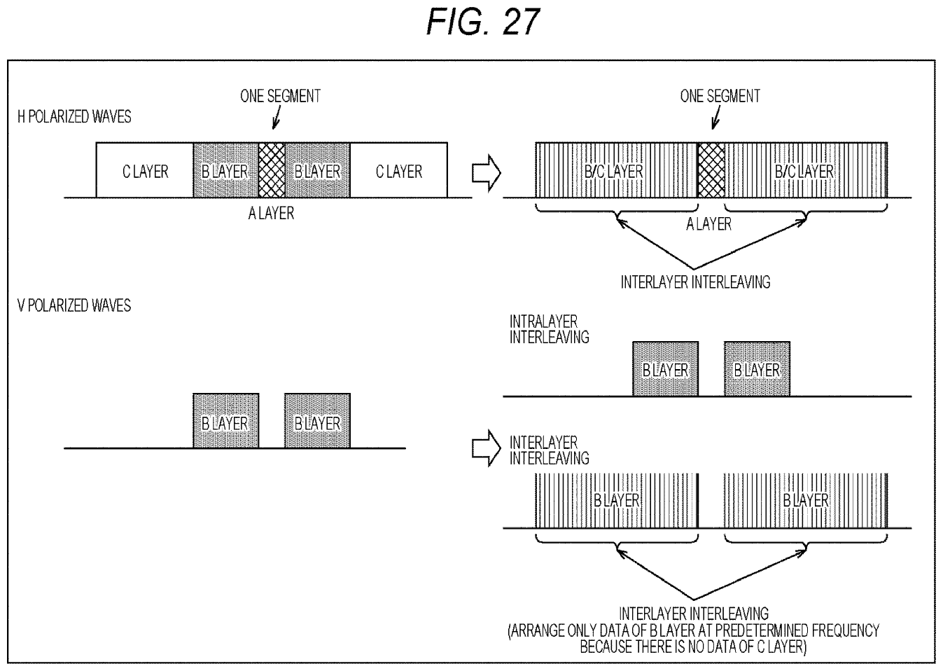

FIG. 27 is a diagram describing frequency interleaving on the V-polarized wave side of broadcasting of the new method in which the MIMO method is used.

FIG. 27 illustrates one channel having thirteen segments of the ISDB-T method as the existing method. In a case where the MIMO method is used to introduce the new method, for example, similarly to FIG. 25, one channel is divided into the three layers, the A layer constituted of one segment, the B layer constituted of five segments, and the C layer constituted of seven segments. Then, one-segment broadcasting is performed on the A layer, for example, 4K broadcasting as the broadcasting of the new method is performed on the B layer, and 2K broadcasting as the broadcasting of the existing method is performed on the C layer.

Note that in FIG. 27, similarly to FIG. 25, only the H polarized waves are used in the one-segment broadcasting of the A layer and the 2K broadcasting of the C layer, and the H polarized waves and the V polarized waves are used in the 4K broadcasting of the B layer.

Types of the frequency interleaving include intralayer interleaving in which the frequency interleaving is performed within the layer of each layer, and interlayer interleaving in which the frequency interleaving is performed over a plurality of layers. Furthermore, different types of frequency interleaving can be performed for each of the H polarized waves and the V polarized waves.

In FIG. 27, for the H polarized waves, the interlayer interleaving is performed over the B layer and the C layer. In this case, for the V polarized waves, the intralayer interleaving can be performed, or the interlayer interleaving can be performed. Regarding the V polarized waves, which frequency interleaving of the intralayer interleaving or the interlayer interleaving is to be performed can be selected according to, for example, factors related to broadcasting performance such as an error rate. This similarly applies to the frequency interleaving performed for the H polarized waves.

In FIG. 27, there is only the B layer for the V polarized waves. Therefore, in a case where the intralayer interleaving is performed for the V polarized waves, the frequency interleaving is performed in the B layer. Furthermore, in a case where the interlayer interleaving is performed over the B layer and the C layer for the V polarized waves, for example, as for the H polarized waves, because the broadcast signal of the B layer exists in the V polarized waves but no broadcast signal exists in the C layer, only the broadcast signal in the B layer is frequency interleaved so as to be arranged over the B layer and the C layer. Thus, regarding the V polarized waves, the arrangement of the broadcast signal of the B layer after the interlayer interleaving is performed becomes what is called a comb shape.

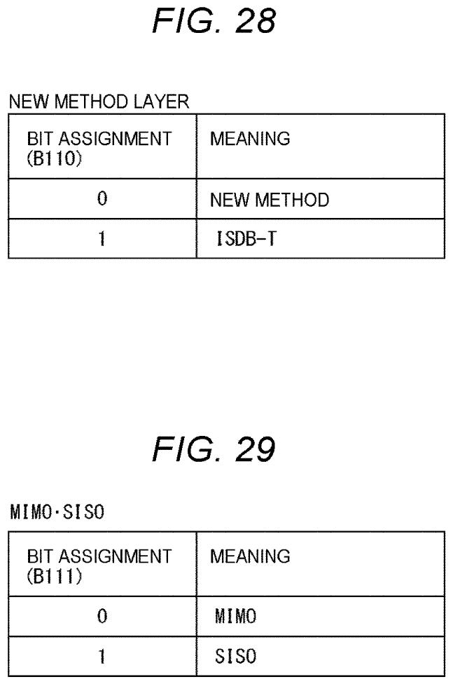

FIG. 28 is a diagram describing the bit B110 to which information indicating that broadcasting performed in the B layer is broadcasting of the ISDB-T method as the existing method or the new method out of the segment control information is assigned.

In a case where ‘0’ is specified as the bit B110, it indicates that the broadcasting performed in the B layer is broadcasting of the new method. In a case where ‘1’ is specified as the bit B110, this indicates that the broadcasting performed in the B layer is broadcasting of the ISDB-T method as the existing method.

FIG. 29 is a diagram describing the bit B111 to which information indicating that broadcasting of the new method performed in the B layer is broadcasting using the SISO method or the MIMO method out of the segment control information is assigned.

In a case where ‘0’ is specified as the bit B111, this indicates that the new method of broadcasting performed in the B layer is broadcasting using the MIMO method. In a case where ‘1’ is specified as the bit B111, this indicates that the new method of broadcasting performed in the B layer is broadcasting using the SISO method.

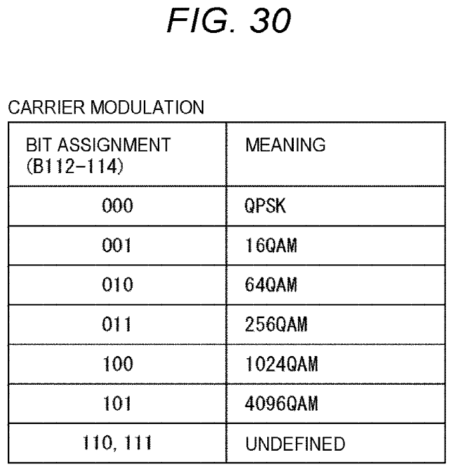

FIG. 30 is a diagram describing bits B112 to B114 to which information representing a carrier modulation method is assigned out of the segment control information.

In a case where ‘000’, ‘001’, ‘010’, ‘011’, ‘100’, and ‘101’ are specified as the bits B112 to B114, this indicates that the modulation methods of broadcasting of the new method performed in the B layer are QPSK, 16QAM, 64QAM, 256QAM, 1024QAM, and 4096QAM, respectively.

Note that in FIG. 30, ‘110’ and ‘111’ in the bits B112 to B114 are undefined.

Furthermore, in FIG. 30, the bits B112 to B114 indicate the modulation method, but the bits B112 to B114 can be defined to indicate, for example, which of uniform constellation (UC) and non-uniform constellation (NUC) the constellation is, together with the modulation method, similarly to FIG. 14 for example.

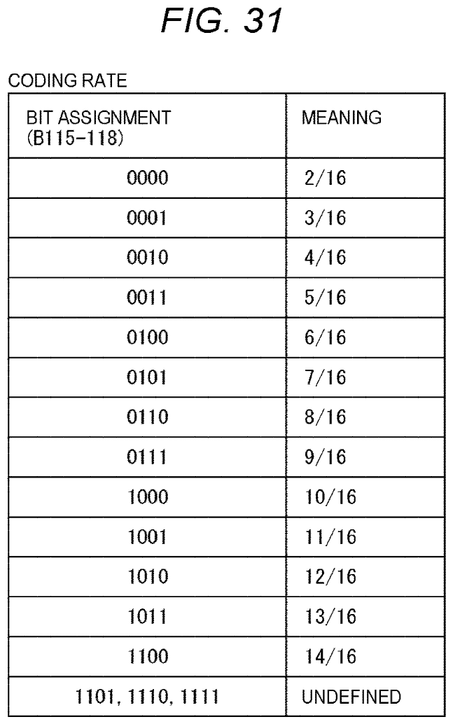

FIG. 31 is a diagram describing bits B115 to B118 to which information representing the coding rate is assigned out of the segment control information.

In a case where ‘0000’, ‘0001’, ‘0010’, ‘0011’, ‘0100’, ‘0101’, ‘0110’, ‘0111’, ‘1000’, ‘1001’, ‘1010’, ‘1011’, and ‘1100’ are specified as the bits B115 to B118, this indicates that the coding rates of broadcasting of the new method performed in the B layer are 2/16, 3/16, 4/16, 5/16, 6/16, 7/16, 8/16, 9/16, 10/16, 11/16, 12/16, 13/16, and 14/16, respectively.

Note that in FIG. 31, ‘1101’, ‘1110’, and ‘1111’ are undefined in the bits B115 to B118.

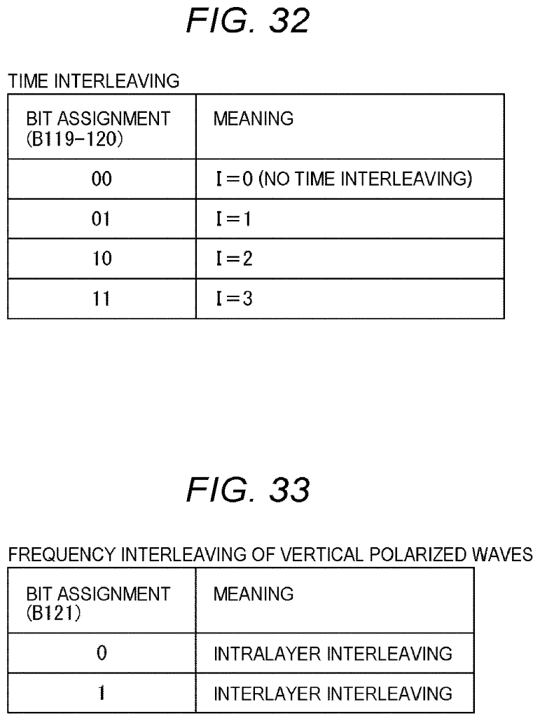

FIG. 32 is a diagram describing bits B119 to B120 to which information representing the length of the time interleaving is assigned out of the segment control information.

In a case where ‘00’, ‘01’, ‘10’, and ‘11’ are specified as the bits B119 to B120, this indicates that the length of the time interleaving is I=0, 1, 2, and 3, respectively.

FIG. 33 is a diagram describing the bit B121 to which, out of the segment control information, information indicating that the frequency interleaving on the V polarized wave side of the broadcasting of the new method using the MIMO method performed in the B layer is the intralayer interleaving or the interlayer interleaving is assigned.

In a case where ‘0’ is specified as the bit B121, this indicates that the frequency interleaving on the V polarized wave side of the broadcasting of the new method performed in the B layer is the intralayer interleaving. In a case where ‘1’ is specified as the bit B121, this indicates that the frequency interleaving on the V polarized wave side of the broadcasting of the new method performed in the B layer is the interlayer interleaving.

Upon introduction of the new method, the transmission device 10 (FIG. 19) can generate and transmit a broadcast signal including the segment control information of FIG. 26. Furthermore, the reception device 20 (FIG. 21) receives the broadcast signal including the segment control information of FIG. 26 and can perform a demodulation process on the basis of this segment control information to acquire video of 4K broadcasting as broadcasting of the new method. Moreover, by assigning the segment control information to the undefined bits B110 to B121 of the TMCC information, the new method can be introduced without affecting reception of broadcasts of the existing method.

(System Identification in Second Phase)

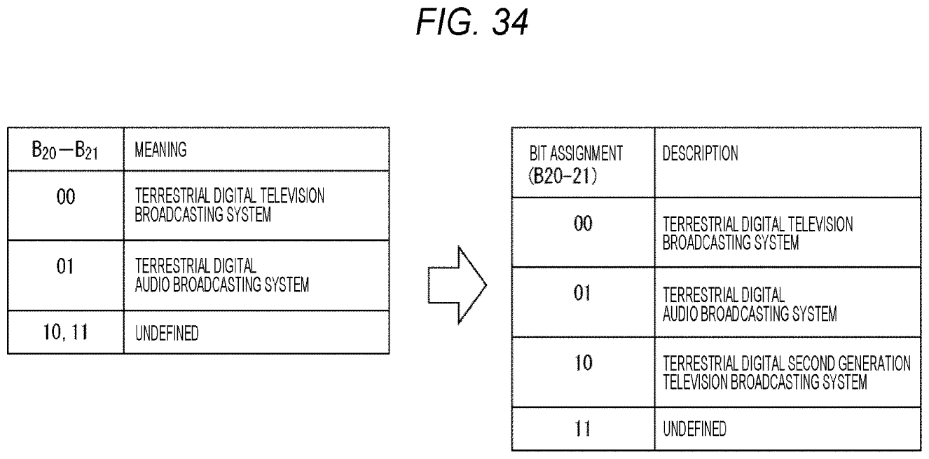

FIG. 34 is a diagram illustrating an example of system identification in the second phase.

In the first phase of introducing the new method while maintaining compatibility with the existing method, current system identification of the ISDB-T method as the existing method needs to be used so as not to affect reception of broadcasts of the existing method. The system identification (FIG. 3) is assigned to the bits B20 to B21 among the bits B20 to B121 of the TMCC information. In a case where the bits B20 to B21 as the current system identification are ‘00’ and ‘01’, respectively, the current system identification represents a terrestrial digital television broadcasting system and a terrestrial digital audio broadcasting system, respectively. In the bits B20 to B21 as the current system identification, ‘10’ and ‘11’ are undefined.

In a case where, after the first phase, it becomes the second phase in which the broadcasting service of the existing method is stopped and only the new method is operated, a new system identification can be defined.

In a case where the bits B20 to B21 as the new system identification are ‘00’ and ‘01’, the new system identification represents the terrestrial digital television broadcasting system and the terrestrial digital audio broadcasting system, respectively, similarly to the current system identification. Moreover, in a case where the bits B20 to B21 as the new system identification are ‘11’, the new system identification represents the broadcasting system of the new method (terrestrial digital second generation television broadcasting system). In the bits B20 to B21 as the new system identification, ‘11’ is undefined.

In a case where the new system identification is employed in the second phase, and the bits B20 to B21 as this new system identification are ‘10’ representing the broadcasting system of the new broadcasting, new control information defined for the new method can be assigned to the bits B22 to B121 excluding the bits B20 to B21 as the new system identification among the bits B20 to B121 as the TMCC information. The reception device 20 can determine whether or not the new control information defined for the new method is assigned to the bits B22 to B121 on the basis of the system identification.

### 2. Modification Example

(Examples of Other Broadcasting Methods)

In the above description, the ISDB-T method has been described as the broadcasting method for terrestrial digital television broadcasting, but the present technology may be applied to other broadcasting methods. Furthermore, it is not limited to ground waves (terrestrial broadcasting) and may be applied to, for example, a broadcasting method such as satellite broadcasting using broadcasting satellites (BS) and communications satellites (CS), or wired broadcasting using cables (common antenna television (CATV)).

(Other Configurations of Reception Device)

Furthermore, while the reception device 20 (FIG. 1) is described as being configured as a fixed receiver such as a television receiver or a set-top box (STB) in the above description, the fixed receiver may include an electronic device, for example, a recorder, a game device, a personal computer, a network storage, or the like. Moreover, the reception device 20 (FIG. 1) is not limited to the fixed receiver, and may include an electronic device, for example, a mobile receiver such as a smartphone, a mobile phone, or a tablet computer, an in-vehicle device mounted on a vehicle such as an in-vehicle television receiver, a wearable computer such as a head mounted display (HMD), or the like.

Moreover, the transmission device 10 having the configuration illustrated in FIG. 19 may be regarded as a modulation device or a modulation unit (for example, a modulation circuit), or the like. Similarly, the reception device 20 having the configuration illustrated in FIG. 21 may be regarded as a demodulation device or a demodulation unit (for example, a demodulation circuit or a demodulation IC), or the like.

(Configuration Including Communication Line)

Furthermore, in the transmission system 1 (FIG. 1), although not illustrated, various servers may be connected to a communication line such as the Internet, so that the reception device 20 (FIG. 1) having the communication function can receive various data such as contents and applications by accessing the various servers and performing interactive communication via the communication line such as the Internet.

(Others)

Note that the terms used in the present disclosure are examples, and the use of other terms is not intentionally excluded. For example, in the above description, a frame may be replaced with, for example, another term such as a packet.

Furthermore, in the present disclosure, the “2K video” is video corresponding to a screen resolution of approximately 1920×1080 pixels, and the “4K video” is video corresponding to a screen resolution of approximately 3840×2160 pixels. Furthermore, in the above description, as broadcast contents, 2K contents of 2K video transmitted by the existing broadcasting method (existing method) and 4K contents of 4K video transmitted by the new broadcasting method (new method) have been described. However, the broadcast content transmitted by the new method may be higher quality content such as 8K video. However, “8K video” is video corresponding to a screen resolution of approximately 7680×4320 pixels.

### 3. Configuration Example of Computer

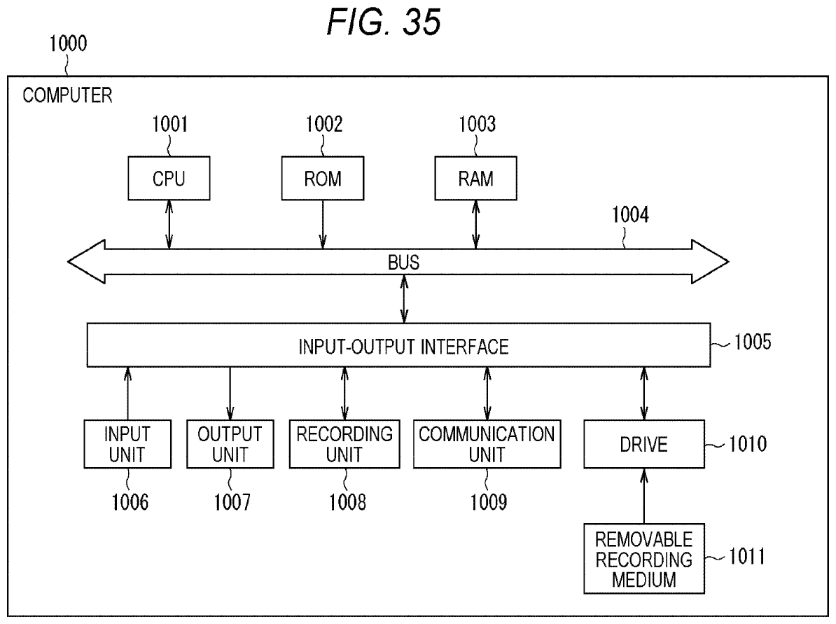

The series of processes described above can be executed by hardware or can be executed by software. In a case where the series of processes is executed by software, a program constituting the software is installed in a computer. FIG. 35 is a diagram illustrating a configuration example of hardware of a computer that executes the above-described series of processes by a program.

In the computer 1000, a central processing unit (CPU) 1001, a read only memory (ROM) 1002, and a random access memory (RAM) 1003 are interconnected via a bus 1004. An input-output interface 1005 is further connected to the bus 1004. An input unit 1006, an output unit 1007, a recording unit 1008, a communication unit 1009, and a drive 1010 are connected to the input-output interface 1005.

The input unit 1006 includes a keyboard, a mouse, a microphone, and the like. The output unit 1007 includes a display, a speaker, and the like. The recording unit 1008 includes a hard disk, a nonvolatile memory, and the like. The communication unit 1009 includes a network interface and the like. The drive 1010 drives a removable recording medium 1011 such as a magnetic disk, an optical disk, a magneto-optical disk, or a semiconductor memory.

In the computer 1000 configured as described above, the CPU 1001 loads, for example, a program recorded in the ROM 1002 or the recording unit 1008 into the RAM 1003 via the input-output interface 1005 and the bus 1004, and executes the program, so as to perform the above-described series of processes.

The program executed by the computer 1000 (CPU 1001) can be provided by being recorded on, for example, a removable recording medium 1011 as a package medium or the like. Furthermore, the program can be provided via a wired or wireless transmission medium such as a local area network, the Internet, or digital satellite broadcasting.

In the computer 1000, the program can be installed in the recording unit 1008 via the input-output interface 1005 by mounting the removable recording medium 1011 to the drive 1010. Furthermore, the program can be received by the communication unit 1009 via a wired or wireless transmission medium and installed in the recording unit 1008. In addition, the program can be installed in the ROM 1002 or the recording unit 1008 in advance.

Here, in the present description, the processing performed by the computer according to the program does not necessarily have to be performed in time series in the order described as the flowchart. That is, the processing performed by the computer according to the program also includes processing that is executed in parallel or individually (for example, parallel processing or object processing). Furthermore, the program may be processed by one computer (processor) or may be processed in a distributed manner by a plurality of computers.

Note that the embodiments of the present technology are not limited to the above-described embodiments, and various modifications are possible without departing from the gist of the present technology.

Furthermore, the present technology can also employ the following configurations.

(1)

A transmission device including:

a generation unit that generates a transmission control signal including segment control information regarding a segment that is a division unit in a frequency domain as control information according to introduction of a second method compatible with a first method; and

a transmission unit that transmits a transmission frame including the transmission control signal that is generated.

(2)

The transmission device according to (1) above, in which

the segment control information includes information indicating that the second method has been introduced into the segment.

(3)

The transmission device according to (1) or (2) above, in which

the segment control information includes information indicating that the second method has been introduced for every layer including the segment.

(4)

The transmission device according to (3) above, in which

the segment control information further includes information regarding a number of segments of each layer for the every layer.

(5)

The transmission device according to any one of (1) to (4) above, in which

an existing region in the transmission control signal is used to indicate a transmission parameter of the second method.

(6)

The transmission device according to (5) above, in which

the transmission parameter includes at least one of a modulation method, a coding rate, or information regarding time interleaving.

(7)

The transmission device according to any one of (1) to (6) above, in which

the transmission control signal further includes information indicating that the second method has been introduced.

(8)

The transmission device according to any one of (1) to (7) above, in which

the first method includes an Integrated Services Digital Broadcasting-Terrestrial (ISDB-T) method,

the second method includes a next generation method of the ISDB-T method,

the transmission frame includes an orthogonal frequency division multiplexing (OFDM) frame, and

the transmission control signal includes a transmission multiplexing configuration control (TMCC) signal.

(9)

The transmission device according to (1), in which

the segment control information includes information indicating that broadcasting of the second method performed in a layer including the segment is broadcasting using a single-input single-output (SISO) method or a multiple input multiple output (MIMO) method.

(10)

The transmission device according to (1) or (9), in which

the segment control information includes information indicating that frequency interleaving on a vertical polarized wave side of broadcasting of the second method performed in the layer including the segment is intralayer interleaving or interlayer interleaving.

(11)

A transmission method including, by a transmission device, generating a transmission control signal including segment control information regarding a segment that is a division unit in a frequency domain as control information according to introduction of a second method compatible with a first method, and transmitting a transmission frame including the transmission control signal that is generated.

(12)

A reception device including:

a reception unit that receives a transmission frame transmitted from a transmission device; and

a demodulation unit that performs a demodulation process on a data signal obtained from the transmission frame on the basis of a transmission control signal obtained from the transmission frame that is received,

in which the transmission control signal includes segment control information regarding a segment that is a division unit in a frequency domain as control information according to introduction of a second method compatible with a first method, and the demodulation unit performs a demodulation process regarding the segment on the basis of the segment control information.

(13)

The reception device according to (12) above, in which

the segment control information includes information indicating that the second method has been introduced into the segment.

(14)

The reception device according to (12) or (13) above, in which

the segment control information includes information indicating that the second method has been introduced for every layer including the segment.

(15)

The reception device according to (14) above, in which

the segment control information further includes information regarding a number of segments of each layer for the every layer.

(16)

The reception device according to any one of (12) to (15) above, in which

an existing region in the transmission control signal is used to indicate a transmission parameter of the second method.

(17)

The reception device according to (16) above, in which

the transmission parameter includes at least one of a modulation method, a coding rate, or information regarding time interleaving.

(18)

The reception device according to any one of (12) to (17) above, in which

the transmission control signal further includes information indicating that the second method has been introduced.

(19)

The reception device according to any one of (12) to (18) above, in which

the first method includes an Integrated Services Digital Broadcasting-Terrestrial (ISDB-T) method,

the second method includes a next generation method of the ISDB-T method,

the transmission frame includes an orthogonal frequency division multiplexing (OFDM) frame, and

the transmission control signal includes a transmission multiplexing configuration control (TMCC) signal.

(20)

The reception device according to (12), in which

the segment control information includes information indicating that broadcasting of the second method performed in a layer including the segment is broadcasting using a single-input single-output (SISO) method or a multiple input multiple output (MIMO) method.

(21)

The reception device according to (12) or (20), in which

the segment control information includes information indicating that frequency interleaving on a vertical polarized wave side of broadcasting of the second method performed in the layer including the segment is intralayer interleaving or interlayer interleaving.

(22)

A reception method including:

by a reception device including

a reception unit that receives a transmission frame transmitted from a transmission device, and

a demodulation unit that performs a demodulation process on a data signal obtained from the transmission frame on the basis of a transmission control signal obtained from the transmission frame that is received,

performing on the basis of segment control information included in the transmission control signal and regarding a segment that is a division unit in a frequency domain as control information according to introduction of a second method compatible with a first method, a demodulation process regarding the segment.

### REFERENCE SIGNS LIST

1 Transmission system
10 Transmission device
11, 11-1 to 11-N Data processing device
20, 20-1 to 20-M Reception device
20D Dual reception device
20L Existing method reception device
20N New method reception device
101 Modulation processing unit
102 Transmission control signal generation unit
103 OFDM modulation unit
201 OFDM demodulation unit
202 Transmission control signal processing unit
203 Demodulation processing unit
1000 Computer
1001 CPU

1. A transmission device comprising:
a generation unit that generates a transmission control signal including segment control information regarding a segment that is a division unit in a frequency domain as control information according to introduction of a second method compatible with a first method; and
a transmission unit that transmits a transmission frame including the transmission control signal that is generated.

2. The transmission device according to claim 1, wherein
the segment control information includes information indicating that the second method has been introduced into the segment.

3. The transmission device according to claim 2, wherein
the segment control information includes information indicating that the second method has been introduced for every layer including the segment.

4. The transmission device according to claim 3, wherein
the segment control information further includes information regarding a number of segments of each layer for the every layer.

5. The transmission device according to claim 1, wherein
an existing region in the transmission control signal is used to indicate a transmission parameter of the second method.

6. The transmission device according to claim 5, wherein
the transmission parameter includes at least one of a modulation method, a coding rate, or information regarding time interleaving.

7. The transmission device according to claim 1, wherein
the transmission control signal further includes information indicating that the second method has been introduced.

8. The transmission device according to claim 1, wherein
the first method includes an Integrated Services Digital Broadcasting-Terrestrial (ISDB-T) method,
the second method includes a next generation method of the ISDB-T method,
the transmission frame includes an orthogonal frequency division multiplexing (OFDM) frame, and
the transmission control signal includes a transmission multiplexing configuration control (TMCC) signal.

9. The transmission device according to claim 1, wherein
the segment control information includes information indicating that broadcasting of the second method performed in a layer including the segment is broadcasting using a single-input single-output (SISO) method or a multiple input multiple output (MIMO) method.

10. The transmission device according to claim 1, wherein
the segment control information includes information indicating that frequency interleaving on a vertical polarized wave side of broadcasting of the second method performed in the layer including the segment is intralayer interleaving or interlayer interleaving.

11. A transmission method comprising, by a transmission device, generating a transmission control signal including segment control information regarding a segment that is a division unit in a frequency domain as control information according to introduction of a second method compatible with a first method, and transmitting a transmission frame including the transmission control signal that is generated.

12. A reception device comprising:
a reception unit that receives a transmission frame transmitted from a transmission device; and
a demodulation unit that performs a demodulation process on a data signal obtained from the transmission frame on a basis of a transmission control signal obtained from the transmission frame that is received,
wherein the transmission control signal includes segment control information regarding a segment that is a division unit in a frequency domain as control information according to introduction of a second method compatible with a first method, and the demodulation unit performs a demodulation process regarding the segment on a basis of the segment control information.

13. The reception device according to claim 12, wherein
the segment control information includes information indicating that the second method has been introduced into the segment.

14. The reception device according to claim 13, wherein
the segment control information includes information indicating that the second method has been introduced for every layer including the segment.

15. The reception device according to claim 14, wherein
the segment control information further includes information regarding a number of segments of each layer for the every layer.

16. The reception device according to claim 12, wherein
an existing region in the transmission control signal is used to indicate a transmission parameter of the second method.

17. The reception device according to claim 16, wherein
the transmission parameter includes at least one of a modulation method, a coding rate, or information regarding time interleaving.

18. The reception device according to claim 12, wherein
the transmission control signal further includes information indicating that the second method has been introduced.

19. The reception device according to claim 12, wherein
the first method includes an Integrated Services Digital Broadcasting-Terrestrial (ISDB-T) method,
the second method includes a next generation method of the ISDB-T method,
the transmission frame includes an orthogonal frequency division multiplexing (OFDM) frame, and
the transmission control signal includes a transmission multiplexing configuration control (TMCC) signal.

20. The reception device according to claim 12, wherein
the segment control information includes information indicating that broadcasting of the second method performed in a layer including the segment is broadcasting using a single-input single-output (SISO) method or a multiple input multiple output (MIMO) method.

21. The reception device according to claim 12, wherein
the segment control information includes information indicating that frequency interleaving on a vertical polarized wave side of broadcasting of the second method performed in the layer including the segment is intralayer interleaving or interlayer interleaving.

22. A reception method comprising:
by a reception device including
a reception unit that receives a transmission frame transmitted from a transmission device, and
a demodulation unit that performs a demodulation process on a data signal obtained from the transmission frame on a basis of a transmission control signal obtained from the transmission frame that is received,
performing on a basis of segment control information included in the transmission control signal and regarding a segment that is a division unit in a frequency domain as control information according to introduction of a second method compatible with a first method, a demodulation process regarding the segment.
